(19) United States
(12) Patent Application Publication
(10) Pub. No.: US 2012/0128069 A1
(43) Pub. Date: May 24, 2012

(54) IMAGE PROCESSING APPARATUS AND METHOD

(76) Inventor: Kazushi Sato, Kanagawa (JP)

(21) Appl. No.: 13/388,471

(22) PCT Filed: Aug. 4, 2010
(86) PCT No.: PCT/JP2010/063156

§ 371 Date: Feb. 2, 2012

(30) Foreign Application Priority Data
Aug. 12, 2009 (JP) 2009-187049

(51) Int. Cl. H04N 7/32

(52) U.S. Cl. 375/240.12; 375/E07.243

(57) ABSTRACT

The present invention relates an image processing apparatus and method able to realize parallelized or pipelined intra prediction while also improving coding efficiency.

An intra prediction unit 74 conducts an intra prediction process on one or more target blocks corresponding to one or more block addresses determined by an address controller 75 in a processing order that differs from the H.264/AVC processing order, in intra prediction modes that use nearby pixels determined to be available by an nearby pixel availability determination unit 76. At this point, the intra prediction unit 74 conducts intra prediction on a plurality of blocks by pipeline processing or parallel processing, or conducts intra prediction on a single block, on the basis of a control signal from a pipeline/parallel processing controller 92. The present invention can be applied to image encoding apparatus that encode in the H.264/AVC format, for example.

### TECHNICAL FIELD

The present invention relates to an image processing apparatus and method, and more particularly, to an image processing apparatus and method configured to realize parallelized or pipelined intra prediction while also improving coding efficiency.

### BACKGROUND ART

Recently, there has been a proliferation of apparatus that digitally handle image information, and when so doing, compress images for the purpose of efficient information transfer and storage. Such apparatus compress images by implementing coding formats that utilize redundancies characteristic of image information and compress information by means of an orthogonal transform such as the discrete cosine transform and by motion compensation. Such coding formats include MPEG (Moving Picture Experts Group), for example.

Particularly, MPEG-2 (ISO/IEC 13818-2) is defined as a general-purpose image coding format, and is a standard encompassing both interlaced scan images and progressive scan images, as well as standard-definition images and high-definition images. For example, at present MPEG-2 is broadly used in a wide range of professional and consumer applications. By using the MPEG-2 compression format, a bit rate from 4 to 8 Mbps is allocated if given a standard-definition interlaced image having 720×480 pixels, for example. Also, by using the MPEG-2 compression format, a bit rate from 18 to 22 Mbps is allocated if given a high-definition interlaced image having 1920×1088 pixels, for example. In so doing, it is possible to realize a high compression rate and favorable image quality.

Although MPEG-2 has primarily targeted high image quality coding adapted for broadcasting, it is not compatible with coding formats having a lower bit rate, or in other words a higher compression rate, than that of MPEG-1. Due to the proliferation of mobile devices, it is thought that the need for such coding formats will increase in the future, and in response the MPEG-4 coding format has been standardized. MPEG-4 was designated an international standard for image coding in December 1998 as ISO/IEC 14496-2.

Furthermore, standardization of H.26L (ITU-T Q6/16 VCEG), which was initially for the purpose of image coding for videoconferencing, has been progressing recently. Compared to previous coding formats such as MPEG-2 and MPEG-4, H.26L is known to place more computational demands for coding and decoding, but higher coding efficiency is realized. Also, as a link to MPEG-4 activity, standardization based on this H.26L that introduces functions which are not supported in H.26L and realizes higher coding efficiency is being currently conducted as the Joint Model of Enhanced-Compression Video Coding. As part of the standardization schedule, H.264 and MPEG-4 Part 10 (Advanced Video Coding, hereinafter abbreviated H.264/AVC) was internationally standardized in March 2003.

Additionally, as an extension of the above, standardization of the FRExt (Fidelity Range Extension) was completed in February 2005. FRExt includes coding tools required for business use, such as RGB, 4:2:2, and 4:4:4, as well as the 8×8 DCT and quantization matrices defined in MPEG-2. In so doing, H.264/AVC can be used for image coding able to favorably express even the film noise included in movies, which has led to its use in a wide range of applications such as Blu-Ray Discs (trademark).

However, needs are growing for coding at even higher compression rates, such as for compressing images having approximately 4000×2000 pixels, four times that of a high-definition image, or for delivering high-definition images in an environment of limited transmission capacity such as the Internet. For this reason, ongoing investigation regarding improved coding efficiency is being conducted by the VCEG (Video Coding Experts Group) under the jurisdiction of the ITU-T discussed earlier.

The operational principle behind intra prediction can be cited as one factor confirming the H.264/AV format's higher coding efficiency compared to conventional formats such as MPEG-2. Hereinafter, intra prediction techniques defined in H.264/AV format will be briefly explained.

First, intra prediction modes for luma signals will be explained. Three types of techniques are defined as intra prediction modes for luma signals: intra 4×4 prediction modes, intra 8×8 prediction modes, and intra 16×16 prediction modes. These are modes defining block units, and are set on a per-macroblock basis. It is also possible to set intra prediction modes for chroma signals independently of luma signals on a per-macroblock basis.

Furthermore, in the case of the intra 4×4 prediction modes, one prediction mode from among nine types of prediction modes can be set for each 4×4 pixel target block. In the case of the intra 8×8 prediction modes, one prediction mode from among nine types of prediction modes can be set for each 8×8 pixel target block. Also, in the case of the intra 16×16 prediction modes, one prediction mode from among four types of prediction modes can be set for a 16×16 pixel target block.

However, the intra 4×4 prediction modes, the intra 8×8 prediction modes, and the intra 16×16 prediction modes will also be respectively designated 4×4 pixel intra prediction modes, 8×8 pixel intra prediction modes, and 16×16 pixel intra prediction modes hereinafter as appropriate.

In the example in FIG. 1, the numbers from −1 to 25 assigned to individual blocks represent the bitstream order of those individual blocks (the order in which they are processed at the decoding end). Herein, for luma signals, macroblocks are divided into 4×4 pixels, and a 4×4 pixel DCT is conducted. Additionally, in the case intra 16×16 prediction modes only, the DC components of the individual blocks are assembled to generate a 4×4 matrix as illustrated by the “−1” block, and an orthogonal transform is additionally applied thereto.

Meanwhile, for chroma signals, macroblocks are divided into 4×4 pixels, and after a 4×4 pixel DCT is conducted, the DC components of the individual blocks are assembled to generate 2×2 matrices as illustrated by the respective “16” and “17” blocks, and an orthogonal transform is additionally applied thereto.

However, for intra 8×8 prediction modes, this is only applicable to the case where an 8×8 orthogonal transform is applied to a target macroblock in the high profile or above.

Herein, given the individual blocks illustrated in FIG. 1, the intra prediction process for the “1” block cannot be initiated unless the sequence of processes for the “0” block ends, for example. This sequence of processes herein refers to an intra prediction process, an orthogonal transform process, a quantization process, a dequantization process, and an inverse orthogonal transform process.

In other words, it has been difficult to process individual blocks in a pipelined or parallel manner with the intra prediction techniques in the H.264/AVC format.

Thus, in PTL 1 there is proposed a method of changing the encoding order and the output order as a compressed image. An encoding order in the method described in PTL 1 is illustrated in A of FIG. 2. An output order as a compressed image in the method described in PTL 1 is illustrated in B of FIG. 2.

In A of FIG. 2, “0, 1, 2a, 3a” are assigned in order from the left to the individual blocks on the first row from the top. “2b, 3b, 4a, 5a” are assigned in order from the left to the individual blocks on the second row from the top. “4b, 5b, 6a, 7a” are assigned in order from the left to the individual blocks on the third row from the top. “6b, 7b, 8, 9” are assigned in order from the left to the individual blocks on the third row from the top. Herein, in the case of the example in A of FIG. 2, blocks assigned the same numbers but different letters represent blocks which can be processed in any order, or in other words, blocks which can be processed in parallel.

In B of FIG. 2, “0, 1, 4, 5” are assigned in order from the left to the individual blocks on the first row from the top. “2, 3, 6, 7” are assigned in order from the left to the individual blocks on the second row from the top. “8, 9, 12, 13” are assigned in order from the left to the individual blocks on the third row from the top. “10, 11, 14, 15” are assigned in order from the left to the individual blocks on the fourth row from the top.

In other words, with the method described in PTL 1, the individual blocks are encoded in ascending order of the numbers assigned to the blocks in A of FIG. 2, sorted in ascending order of the numbers assigned to the blocks in B of FIG. 2, and output as a compressed image.

Consequently, in A of FIG. 2, it is possible to process two blocks assigned the same number but different letters (for example, the block assigned “2a” and the block assigned “2b”), regardless of the availability of nearby blocks. Thus, pipeline processing or parallel processing can be conducted in the encoding process of the method described in PTL 1.

Also, as discussed earlier, the macroblock size is 16×16 pixels in the H.264/AVC format. However, taking the macroblock size to be 16×16 pixels is not optimal for large image sizes such as UHD (Ultra High Definition; 4000×2000 pixels), which is targeted for next-generation coding formats.

Thus, in literature such as NPL 1, it is also proposed that the macroblock size be extended to sizes such as 32×32 pixels, for example.

Herein, FIGS. 1 and 2 discussed above will also be used as drawings for describing the present invention hereinafter.

### CITATION LIST

### Patent Literature

PTL 1: Japanese Unexamined Patent Application Publication No. 2005-130509

### Non Patent Literature

NPL 1: “Video Coding Using Extended Block Sizes”, VCEG-AD09, ITU-Telecommunications Standardization Sector STUDY GROUP Question 16—Contribution 123, January 2009.

### SUMMARY OF INVENTION

### Technical Problem

However, in PTL 1 a buffer to store already-encoded data becomes necessary since the encoding order and the output order as a compressed order differ. Also, adjacent pixel values which are available under the processing order illustrated in A of FIG. 2 may be unavailable under the processing order illustrated in B of FIG. 2.

For these reasons, even though encoding processes can be processed in parallel with the method in PTL 1, it has been difficult to obtain the fundamental coding efficiency that should be obtained as a result of the encoding in the processing order illustrated in A of FIG. 2.

The present invention, being devised in light of such circumstances, realizes parallelized or pipelined intra prediction while also improving coding efficiency.

### Solution to Problem

An image processing apparatus of a first aspect of the present invention comprises address controlling means for determining, on the basis of an order that differs from that of an encoding standard, the one or more block addresses of one or more target blocks to be processed next from among the blocks constituting a given block of an image, encoding means for conducting a prediction process using pixels near the one or more target blocks and encoding the one or more target blocks corresponding to the one or more block addresses determined by the address controlling means, and stream outputting means for outputting the one or more target blocks as a stream in the order encoded by the encoding means.

In the case where the given block is composed of 16 blocks with the upper-left block taken to be (0,0) and blocks enclosed in curly brackets { } indicating that they may be processed by pipeline processing, parallel processing, or in any order, the address controlling means may determine the one or more block addresses of the one or more target blocks on the basis of the order (0,0), (1,0), {(2,0), (0,1)}, {(3,0), (1,1)}, {(2,1), (0,2)}, {(3,1), (1,2)}, {(2,2), (0,3)}, {(3,2), (1,3)}, (2,3), (3,3).

The image processing apparatus may further comprise nearby pixel availability determining means for using the one or block addresses determined by the address controlling means to determine whether or not pixels near the one or more target blocks are available, wherein the encoding means encodes the one or more target blocks by conducting a prediction process using pixels near the one or more target blocks in prediction modes that use nearby pixels determined to be available by the nearby pixel availability determining means.

The image processing apparatus may further comprise processing determining means for using the one or more block addresses determined by the address controlling means to determine whether or not the one or more target blocks can be processed by pipeline processing or parallel processing, wherein in the case where it is determined by the processing determining means that the one or more target blocks can be processed by pipeline processing or parallel processing, the encoding means encodes the target blocks by pipeline processing or parallel processing.

The given block is an m×m pixel (where m≧16) macroblock, and blocks constituting the given block are m/4×m/4 pixel blocks.

The given block is an m×m pixel (where m≧32) macroblock or a sub-block constituting part of the macroblock, and blocks constituting the given block are 16×16 pixel blocks.

An image processing method of a first aspect of the present invention includes steps whereby an image processing apparatus determines, on the basis of an order that differs from that of an encoding standard, the one or more block addresses of one or more target blocks to be processed next from among the blocks constituting a given block of an image, conducts a prediction process using pixels near the one or more target blocks and encodes the one or more target blocks corresponding to the determined one or more block addresses, and outputs the one or more target blocks as a stream in the encoded order.

An image processing apparatus of a second aspect of the present invention comprises decoding means for decoding one or more target blocks to be processed next, the one or more target blocks being blocks constituting a given block of an image which have been encoded and then output as a stream in an order in the given block that differs from that of an encoding standard, with the decoding means decoding the one or more target blocks in the stream order, address controlling means for determining the one or more block addresses of the one or more target blocks on the basis of the order that differs from that of an encoding standard, predicting means for using pixels near the one or more target blocks to predict one or more predicted images of the one or more target blocks corresponding to the one or more block addresses determined by the address controlling means, and adding means for adding one or more predicted images of the one or more target blocks predicted by the predicting means to one or more images of the one or more target blocks decoded by the decoding means.

In the case where the given block is composed of 16 blocks with the upper-left block taken to be (0,0) and blocks enclosed in curly brackets { } indicating that they may be processed by pipeline processing, parallel processing, or in any order, the address controlling means may determine the one or more block addresses of the one or more target blocks on the basis of the order (0,0), (1,0), {(2,0), (0,1)}, {(3,0), (1,1)}, {(2,1), (0,2)}, {(3,1), (1,2)}, {(2,2), (0,3)}, {(3,2), (1,3)}, (2,3), (3,3).

The image processing apparatus may further comprise nearby pixel availability determining means for using the one or block addresses determined by the address controlling means to determine whether or not pixels near the one or more target blocks are available, wherein the decoding means also decodes prediction mode information for the one or more target blocks, and the predicting means uses pixels near the one or more target blocks determined to be available by the nearby pixel availability determining means to predict one or more predicted images of the one or more target blocks in one or more prediction modes indicated by the prediction mode information.

The image processing apparatus may further comprise processing determining means for using the one or more block addresses determined by the address controlling means to determine whether or not the one or more target blocks can be processed by pipeline processing or parallel processing, wherein in the case where it is determined by the processing determining means that the one or more target blocks can be processed by pipeline processing or parallel processing, the encoding means predicts predicted images of the target blocks by pipeline processing or parallel processing.

The given block is an m×m pixel (where m≧16) macroblock, and blocks constituting the given block are m/4×m/4 pixel blocks.

The given block is an m×m pixel (where m≧32) macroblock or a sub-block constituting part of the macroblock, and blocks constituting the given block are 16×16 pixel blocks.

An image processing method of a second aspect of the present invention includes steps whereby an image processing apparatus decodes one or more target blocks to be processed next, the one or more target blocks being blocks constituting a given block of an image which have been encoded and then output as a stream in an order in the given block that differs from that of an encoding standard, with the one or more target blocks being decoded in the stream order, determines the one or more block addresses of the one or more target blocks on the basis of the order that differs from that of an encoding standard, uses pixels near the one or more target blocks to predict one or more predicted images of the one or more target blocks corresponding to the determined one or more block addresses, and adds one or more predicted images of the one or more target blocks thus predicted to one or more images of the decoded one or more target blocks.

In a first aspect of the present invention, the one or more block addresses of one or more target blocks to be processed next from among the blocks constituting a given block of an image are determined on the basis of an order that differs from that of an encoding standard, a prediction process using pixels near the one or more target blocks is conducted, the one or more target blocks corresponding to the determined one or more block addresses are encoded, and the one or more target blocks are output as a stream in the encoded order.

In a second aspect of the present invention, one or more target blocks to be processed next are decoded, the one or more target blocks being blocks constituting a given block of an image which have been encoded and then output as a stream in an order in the given block that differs from that of an encoding standard, with the one or more target blocks being decoded in the stream order. One or more block addresses of the one or more target blocks are determined on the basis of the order that differs from that of an encoding standard, pixels near the one or more target blocks are used to predict one or more predicted images of the one or more target blocks corresponding to the determined one or more block addresses. Then, the one or more predicted images of the one or more target blocks thus predicted are added to one or more images of the decoded one or more target blocks.

Furthermore, the respective image processing apparatus discussed above may be independent apparatus, or internal blocks constituting part of a single image encoding apparatus or image decoding apparatus.

### Advantageous Effects of Invention

According to a first aspect of the present invention, blocks constituting a given block can be encoded. Also, according to a first aspect of the present invention, pipelined or parallelized intra prediction can be realized while also improving coding efficiency.

According to a second aspect of the present invention, blocks constituting a given block can be decoded. Also, according to a second aspect of the present invention, pipelined or parallelized intra prediction can be realized while also improving coding efficiency.

### BRIEF DESCRIPTION OF DRAWINGS

FIG. 1 is a diagram explaining a processing order in the case of a 16×16 pixel intra prediction mode.

FIG. 2 is a diagram illustrating an exemplary encoding order and a stream output order.

FIG. 3 is a block diagram illustrating a configuration of an embodiment of an image encoding apparatus to which the present invention has been applied.

FIG. 4 is a block diagram illustrating an exemplary configuration of an address controller.

FIG. 5 is a timing chart explaining parallel processing and pipeline processing.

FIG. 6 is a diagram explaining advantages of the present invention.

FIG. 7 is a flowchart explaining an encoding process of the image encoding apparatus in FIG. 3.

FIG. 8 is a flowchart explaining the prediction process in step S21 of FIG. 7.

FIG. 9 is a diagram illustrating types of 4×4 pixel intra prediction modes for luma signals.

FIG. 10 is a diagram illustrating types of 4×4 pixel intra prediction modes for luma signals.

FIG. 11 is a diagram explaining directions of 4×4 pixel intra prediction.

FIG. 12 is a diagram explaining 4×4 pixel intra prediction.

FIG. 13 is a diagram explaining encoding in 4×4 pixel intra prediction modes for luma signals.

FIG. 14 is a diagram illustrating types of 8×8 pixel intra prediction modes for luma signals.

FIG. 15 is a diagram illustrating types of 8×8 pixel intra prediction modes for luma signals.

FIG. 16 is a diagram illustrating types of 16×16 pixel intra prediction modes for luma signals.

FIG. 17 is a diagram illustrating types of 16×16 pixel intra prediction modes for luma signals.

FIG. 18 is a diagram explaining 16×16 pixel intra prediction.

FIG. 19 is a diagram illustrating types of intra prediction modes for chroma signals.

FIG. 20 is a flowchart explaining the intra prediction pre-processing in step S31 of FIG. 8.

FIG. 21 is a flowchart explaining the intra prediction process in step S32 of FIG. 8.

FIG. 22 is a flowchart explaining the inter motion prediction process in step S33 of FIG. 8.

FIG. 23 is a block diagram illustrating a configuration of an embodiment of an image decoding apparatus to which the present invention has been applied.

FIG. 24 is a block diagram illustrating an exemplary configuration of an address controller.

FIG. 25 is a flowchart explaining a decoding process of the image decoding apparatus in FIG. 23.

FIG. 26 is a flowchart explaining the prediction process in step S138 of FIG. 25.

FIG. 27 is a diagram illustrating exemplary extended block sizes.

FIG. 28 is a diagram illustrating an exemplary application of the present invention to extended block sizes.

FIG. 29 is a block diagram illustrating an exemplary hardware configuration of a computer.

FIG. 30 is a block diagram illustrating an exemplary primary configuration of a television receiver to which the present invention has been applied.

FIG. 31 is a block diagram illustrating an exemplary primary configuration of a mobile phone to which the present invention has been applied.

FIG. 32 is a block diagram illustrating an exemplary primary configuration of a hard disk recorder to which the present invention has been applied.

FIG. 33 is a block diagram illustrating an exemplary primary configuration of a camera to which the present invention has been applied.

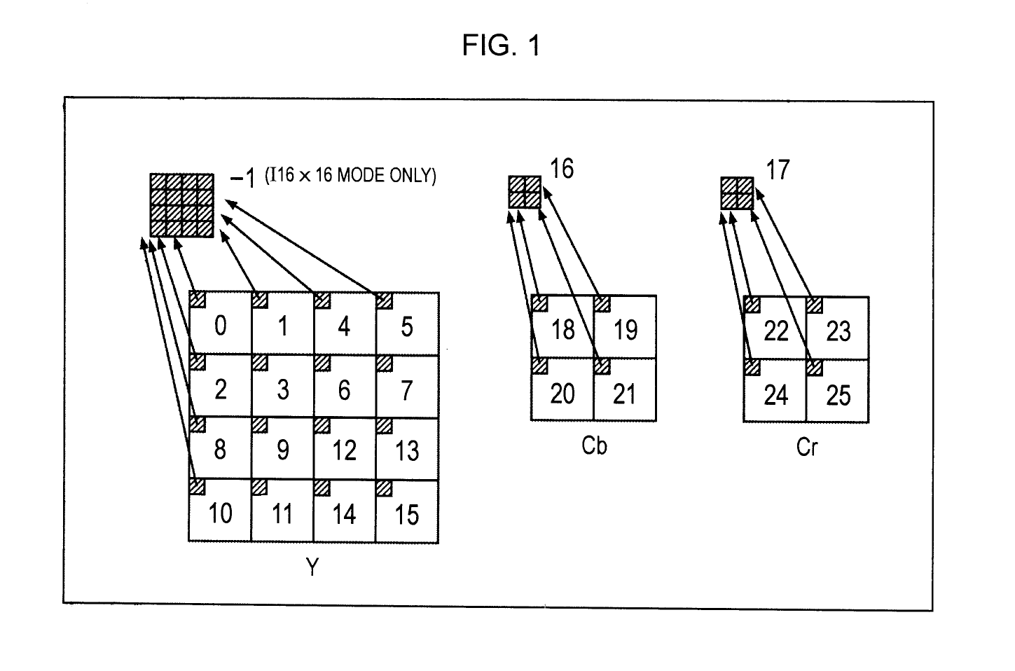

### DESCRIPTION OF EMBODIMENTS

Hereinafter, embodiments of the present invention will be described with reference to the drawings.

### [Exemplary Configuration of Image Encoding Apparatus]

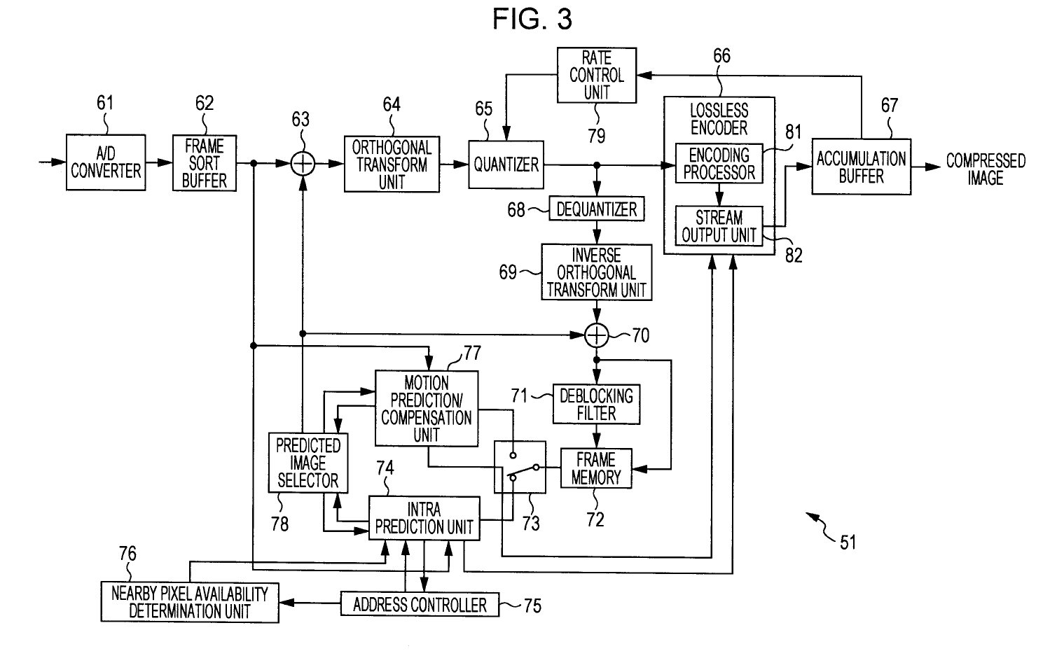

FIG. 3 illustrates a configuration of an embodiment of an image encoding apparatus as an image processing apparatus to which the present invention has been applied.

The image encoding apparatus 51 conducts compression coding of images in the H.264 and MPEG-4 Part 10 (Advanced Video Coding) format (hereinafter abbreviated H.264/AVC), for example.

In the example in FIG. 3, the image encoding apparatus 51 comprises an A/D converter 61, a frame sort buffer 62, an arithmetic unit 63, an orthogonal transform unit 64, a quantizer 65, a lossless encoder 66, an accumulation buffer 67, a dequantizer 68, an inverse orthogonal transform unit 69, and an arithmetic unit 70. The image encoding apparatus 51 also comprises a deblocking filter 71, frame memory 72, a switch 73, an intra prediction unit 74, an address controller 75, a nearby pixel availability determination unit 76, a motion prediction/compensation unit 77, a predicted image selector 78, and a rate controller 79.

The A/D converter 61 A/D converts an input image and outputs it to the frame sort buffer 62 for storage. The frame sort buffer 62 takes stored images of frames in display order and sorts them in a frame order for encoding according to a GOP (Group of Pictures).

The arithmetic unit 63 subtracts a predicted image from the intra prediction unit 74 or a predicted image from the motion prediction/compensation unit 77, selected by the predicted image selector 78, from an image read out from the frame sort buffer 62, and outputs the difference information to the orthogonal transform unit 64. The orthogonal transform unit 64 applies an orthogonal transform such as the discrete cosine transform or the Karhunen-Loeve transform to the difference information from the arithmetic unit 63, and outputs the transform coefficients. The quantizer 65 quantizes the transform coefficients output by the orthogonal transform unit 64.

The quantized transform coefficients output from the quantizer 65 are input into the lossless encoder 66. At this point, lossless coding such as variable-length coding and arithmetic coding are performed, and the quantized transform coefficients are compressed.

The lossless encoder 66 acquires information indicating intra prediction, etc. from the intra prediction unit 74, and acquires information indicating an inter prediction mode, etc. from the motion prediction/compensation unit 77. Herein, information indicating intra prediction will be hereinafter also referred to as intra prediction mode information. Also, information indicating information modes indicating inter prediction will be hereinafter also referred to as inter prediction mode information.

In the case of the example in FIG. 3, the lossless encoder 66 is composed of an encoding processor 81 and a stream output unit 82. The encoding processor 81 encodes the quantized transform coefficients in a processing order that differs from the processing order in H.264/AVC, and additionally encodes information indicating intra prediction and information indicating an inter prediction mode, etc., which is taken to be part of the header information in a compressed image. The stream output unit 82 outputs encoded data as a stream in an output order that is the same as the encoding order, outputting to the accumulation buffer 67 for storage.

Herein, the processing order discussed above is the processing order for the case of encoding a predicted image from the intra prediction unit 74. Although not specifically mentioned hereinafter, encoding processing and output processing is taken to be conducted in the H.264/AVC processing order in the case of predicted image from the motion prediction/compensation unit 77.

Herein, in the lossless encoder 66, a lossless encoding process such as variable-length coding or arithmetic coding is conducted. CAVLC (Context-Adaptive Variable Length Coding) defined in the H.264/AVC format may be cited as the variable-length coding. CABAC (Context-Adaptive Binary Arithmetic Coding) may be cited as the arithmetic coding.

The accumulation buffer 67 takes data supplied from the lossless encoder 66 and outputs it to, for example, a subsequent recording apparatus, transmission path, etc. not illustrated as a compressed image encoded by the H.264/AVC format.

Also, the quantized transform coefficients output by the quantizer 65 are also input into the dequantizer 68, and after being dequantized, are also subjected to an inverse orthogonal transform at the inverse orthogonal transform unit 69. The inverse orthogonally transformed output is added to a predicted image supplied from the predicted image selector 78 by the arithmetic unit 70 and becomes a locally decoded image. The deblocking filter 71 supplies the decoded image to the frame memory 72 for storage after removing blocking artifacts therefrom. The image from before the deblocking process was performed by the deblocking filter 71 is also supplied to and stored in the frame memory 72.

The switch 73 outputs a reference image stored in the frame memory 72 to the motion prediction/compensation unit 77 or the intra prediction unit 74.

In this image encoding apparatus 51, I-pictures, B-pictures, and P-pictures from the frame sort buffer 62 are supplied to the intra prediction unit 74 as images for intra prediction (also called intra processing), for example. Also, B-pictures and P-pictures read out from the frame sort buffer 62 are supplied to the motion prediction/compensation unit 77 as images for inter prediction (also called inter processing).

The intra prediction unit 74 conducts an intra prediction process in all intra prediction modes given as candidates, and generates predicted images on the basis of an image to intra predict which is read out from the frame sort buffer 62 and a reference image supplied from the frame memory 72.

At this point, the intra prediction unit 74 supplies the address controller 75 with information on the next processing number, which indicates which block or blocks in a macroblock are to be processed next. In response, the intra prediction unit 74 acquires from the address controller 75 one or more block addresses and a control signal which controls or forbids pipeline processing or parallel processing. The intra prediction unit 74 also acquires information on the availability of pixels near the one or more target blocks to be processed from the nearby pixel availability determination unit 76.

The intra prediction unit 74 conducts an intra prediction process on the one or more blocks corresponding to one or more block addresses from the address controller 75 in intra prediction modes that use nearby pixels determined to be available by the nearby pixel availability determination unit 76. Furthermore, the intra prediction unit 74 conducts intra prediction on those blocks by pipeline processing or parallel processing at this point in the case where a control signal that controls pipeline processing or parallel processing has been received from the address controller 75.

The intra prediction unit 74 computes cost function values for intra prediction modes which have generated predicted images, and selects the intra prediction mode whose computed cost function value gives the minimum value as the optimal intra prediction mode. The intra prediction unit 74 supplies a generated predicted image and its corresponding cost function value computed for the optimal intra prediction mode to the predicted image selector 78.

In the case where the predicted image generated with the optimal intra prediction mode is selected by the predicted image selector 78, the intra prediction unit 74 supplies information indicating the optimal intra prediction mode to the lossless encoder 66. In the case where information is transmitted from the intra prediction unit 74, the lossless encoder 66 encodes this information, which is taken to be part of the header information in a compressed image.

The address controller 75, upon acquiring processing number information from the intra prediction unit 74, computes the one or more block addresses to be processed next in a processing order that differs from the H.264/AVC processing order, and supplies the one or more block addresses to the intra prediction unit 74 and the nearby pixel availability determination unit 76.

The address controller 75 also uses the computed one or more block addresses to determine whether or not pipeline processing or parallel processing of target blocks is possible. Depending on the determination result, the address controller 75 supplies the intra prediction unit 74 with a control signal that controls or forbids pipeline processing or parallel processing.

The nearby pixel availability determination unit 76 uses one or more block addresses from the address controller 75 to determine the availability of pixels near the one or more target blocks, and supplies information on the determined availability of nearby pixels to the intra prediction unit 74.

The motion prediction/compensation unit 77 conducts a motion prediction/compensation process in all inter prediction modes given as candidates. In other words, the motion prediction/compensation unit 77 is supplied with an image to be inter processed which is read out from the frame sort buffer 62, and a reference image from the frame memory 72 via the switch 73. On the basis of the image to be inter processed and the reference image, the motion prediction/compensation unit 77 detects motion vectors in all inter prediction modes given as candidates and compensates the reference image on the basis of the motion vectors to generate predicted images.

Also, the motion prediction/compensation unit 77 computes cost function values for all inter prediction modes given as candidates. The motion prediction/compensation unit 77 determines the optimal inter prediction mode to be the prediction mode giving the minimum value from among the computed cost function values.

The motion prediction/compensation unit 77 supplies the predicted image generated with the optimal inter prediction mode and its cost function value to the predicted image selector 78. In the case where the predicted image generated with the optimal inter prediction mode is selected by the predicted image selector 78, the motion prediction/compensation unit 77 outputs information indicating the optimal inter prediction mode (inter prediction mode information) to the lossless encoder 66.

Furthermore, motion vector information, flag information, and reference frame information, etc. is also output to the lossless encoder 66 as necessary. The lossless encoder 66 likewise performs a lossless encoding process such as variable-length coding or arithmetic coding on the information from the motion prediction/compensation unit 77 and inserts it into the compressed image header.

The predicted image selector 78 determines the optimal prediction mode from between the optimal intra prediction mode and the optimal inter prediction mode, on the basis of the respective cost function values output by the intra prediction unit 74 and the motion prediction/compensation unit 77. Then, the predicted image selector 78 selects the predicted image of the optimal prediction mode thus determined, and supplies it to the arithmetic units 63 and 70. At this point, the predicted image selector 78 supplies predicted image selection information to the intra prediction unit 74 or the motion prediction/compensation unit 77.

The rate controller 79 controls the rate of quantization operations by the quantizer 65 such that overflow or underflow does not occur, on the basis of compressed images stored in the accumulation buffer 67.

### [Exemplary Configuration of Address Controller]

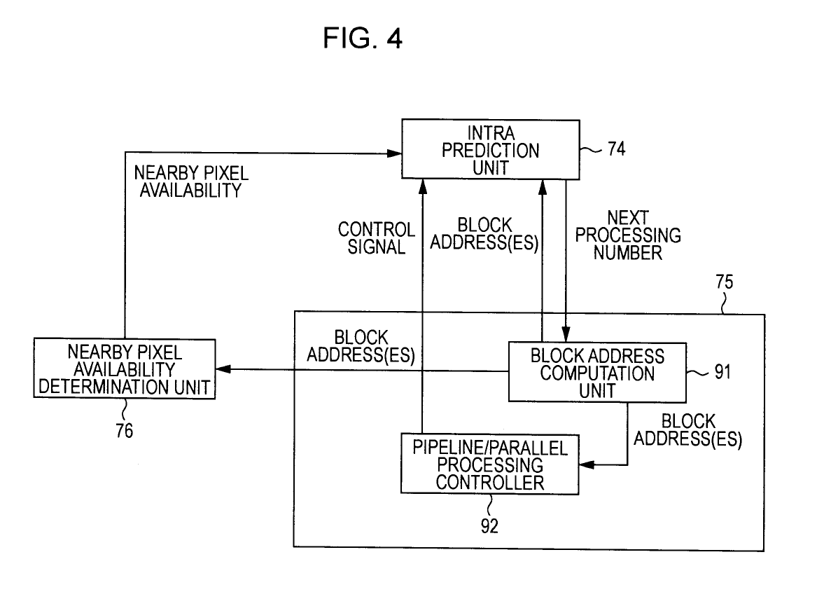

FIG. 4 is a block diagram illustrating an exemplary configuration of an address controller.

In the case of the example in FIG. 4, the address controller 75 is composed of a block address computation unit 91 and a pipeline/parallel processing controller 92.

The intra prediction unit 74 supplies the block address computation unit 91 with information on the next processing number for one or more blocks in a macroblock. For example, in the case where a macroblock consisting of 16×16 pixels is composed of 16 blocks consisting of 4×4 pixels, the next processing number is information indicating which blocks from the 1st up to the 16th have been processed, and which are to be processed next.

From a processing number from the intra prediction unit 74, the block address computation unit 91 computes and determines the block addresses of one or more target blocks to be processed next in a processing order that differs from the H.264/AVC processing order. The block address computation unit 91 supplies the determined one or more block addresses to the intra prediction unit 74, the pipeline/parallel processing controller 92, and the nearby pixel availability determination unit 76.

The pipeline/parallel processing controller 92 uses one or more block addresses from the block address computation unit 91 to determine whether or not pipeline processing or parallel processing of target blocks is possible. Depending on the determination result, the pipeline/parallel processing controller 92 supplies the intra prediction unit 74 with a control signal that controls or forbids pipeline processing or parallel processing.

The nearby pixel availability determination unit 76 uses one or more block addresses from the block address computation unit 91 to determine the availability of pixels near one or more target blocks, and supplies information on the determined availability of nearby pixels to the intra prediction unit 74.

The intra prediction unit 74 conducts an intra prediction process on one or more target blocks corresponding to one or more block addresses from the block address computation unit 91 in intra prediction modes that use nearby pixels determined to be available by the nearby pixel availability determination unit 76. Also, at this point, the intra prediction unit 74 conducts intra prediction on a plurality of blocks by pipeline processing or parallel processing, or conducts intra prediction on just a single block, on the basis of a control signal from the pipeline/parallel processing controller 92.

### [Description of Processing Order in Image Encoding Apparatus]

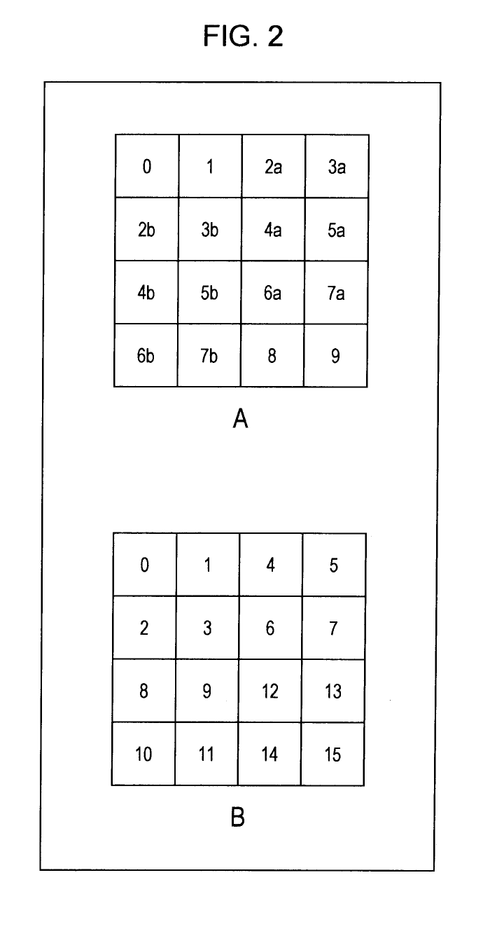

Next, the processing order in the image encoding apparatus 51 will be described with reference to FIG. 2 again. Herein, a case where, for example, a macroblock consisting of 16×16 pixels is composed of 16 blocks consisting of 4×4 pixels will be described as an example.

In the image encoding apparatus 51, respective blocks in a macroblock are encoded in order of the numbers assigned to the respective blocks in A of FIG. 2, or in other words, in the order 0, 1, {2a,2b}, {3a,3b}, {4a,4b}, {5a,5b}, {6a,6b}, {7a,7b}, 8, 9. Then, in the image encoding apparatus 51, the encoded blocks are output as a stream in the same order as the encoding order. Herein, encoding in order of the numbers in A of FIG. 2 in other words refers to conducting intra prediction, orthogonal transformation, quantization, dequantization, and inverse orthogonal transformation in order of the numbers in A of FIG. 2.

Herein, {2a,2b} for example indicates that either may be processed first. For {2a,2b}, processing of one may be initiated even if processing of the other has not finished. In other words, pipeline processing is possible, and parallel processing is possible.

For example, H.264/AVC encoding is conducted in order of the numbers assigned to the respective blocks in B of FIG. 2. Additionally, a block assigned with a particular number hereinafter will also be referred to as block “(number)”.

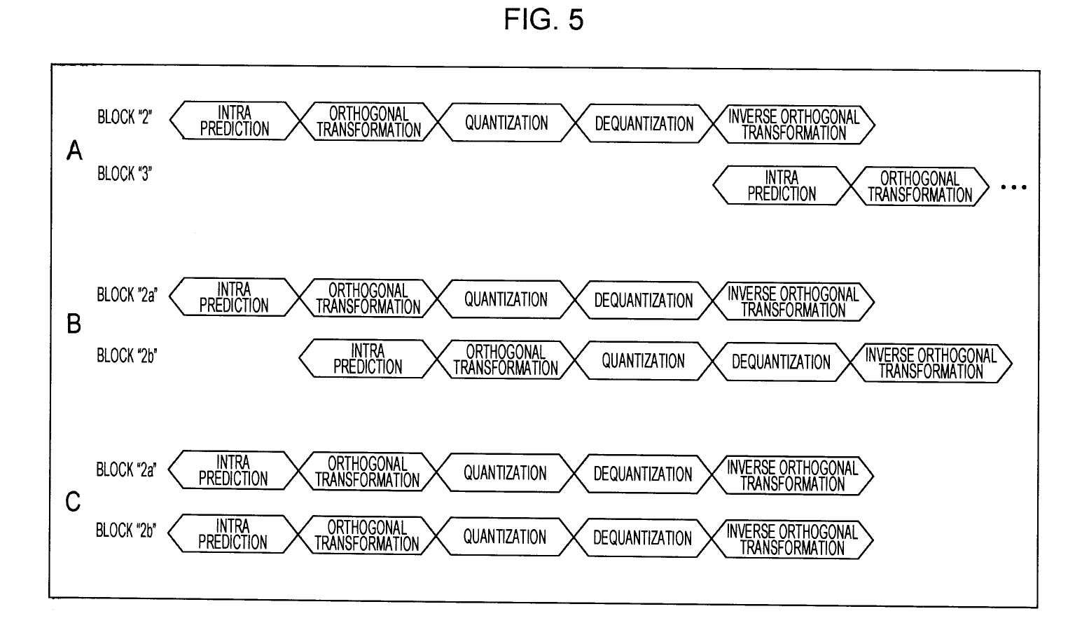

In the case of H.264/AVC, for block “2” and block “3” illustrated in B of FIG. 2, block “3” cannot be intra predicted unless local decoding (inverse orthogonal transformation) of block “2” is completed, as illustrated in A of FIG. 5.

For example, the example in A of FIG. 5 illustrates a timing chart for the case of the H.264/AVC encoding order, or in other words for block “2” and block “3” illustrated in B of FIG. 2. In the case of A of FIG. 5, intra prediction of block “3” is initiated after intra prediction, orthogonal transformation, quantization, dequantization, and inverse orthogonal transformation of block “2” is completed.

In this way, in the case of H.264/AVC, nearby pixel values for intra predicting block “3” are unknown unless local decoding (inverse orthogonal transformation) of block “2” is completed. For this reason, conducting pipeline processing has been difficult.

In contrast, in the case of the encoding order and the output order of the image encoding apparatus 51, no interdependency regarding nearby pixels exists between block “2a” and block “2b” illustrated in A of FIG. 2, and thus processing like that illustrated in the following B of FIG. 5 and C of FIG. 5 is possible.

For example, the example in B of FIG. 5 illustrates a pipeline processing timing chart for the case of the encoding and output order of the image encoding apparatus 51, or in other words for block “2a” and block “2b” illustrated in A of FIG. 2. In the case of B of FIG. 5, after intra prediction of block “2a” is completed, orthogonal transformation of block “2a” is initiated, while intra prediction of block “2b” is simultaneously initiated without being affected by the processing of block “2a”. Subsequent quantization, dequantization, and inverse orthogonal transformation of block “2a” is likewise conducted without being affected by the processing of block “2b”, while orthogonal transformation, quantization, dequantization, and inverse orthogonal transformation of block “2b” is likewise conducted without being affected by the processing of block “2a”.

The example in C of FIG. 5 illustrates a parallel processing timing chart for the case of the encoding and output order of the image encoding apparatus 51, or in other words, for block “2a” and block “2b” illustrated in A of FIG. 2. In the case of C of FIG. 5, intra prediction of block “2a” and intra prediction of block “2b” are simultaneously initiated. Subsequent orthogonal transformation, quantization, dequantization, and inverse orthogonal transformation of block “2a”, as well as orthogonal transformation, quantization, dequantization, and inverse orthogonal transformation of block “2b”, are also respectively conducted simultaneously.

As above, for block “2a” and block “2b” illustrated in A of FIG. 2, pipeline processing like that illustrated in B of FIG. 5 and parallel processing illustrated in C of FIG. 5 are possible.

Meanwhile, in the proposal described in PTL 1 discussed earlier, the order of the encoding process is in order of the assigned numbers in A of FIG. 2, but the order of output to a stream is in order of the assigned numbers in B of FIG. 2. Consequently, a buffer for reordering has been necessary. In contrast, in the image encoding apparatus 51 it is not necessary to provide a buffer between the encoding processor 81 and the stream output unit 82, since the encoding order and the output order are the same.

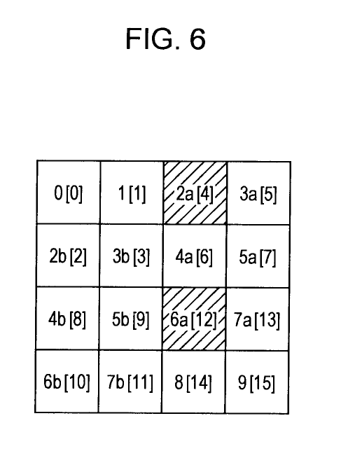

Also consider block “3b” or block “7b” illustrated in FIG. 6. In the example in FIG. 6, numbers indicating the encoding order are assigned to the respective blocks, while the assigned numbers in brackets adjacent to those numbers represent the output order in the proposal described in PTL 1.

For example, in the case of processing block “3b”, processing of block “2a” which is shaded in FIG. 6 should have already finished. Similarly for block “7b”, in the case of processing block “7b”, processing of block “6a” which is shaded in FIG. 6 should have already finished. Consequently, when considering the processing order, the nearby pixel values to the upper-right of block “3b” and block “7b” are available.

However, if the output order is taken to be that of the numbers in brackets, block “3b” is 3rd in the output order whereas block “2a” is 4th in the output order, and thus block “2a” will be output after block “3b”.

Block “7b” is 11th in the output order whereas block “6a” is 12th in the output order, and thus block “6a” will be output after block “7b”.

Consequently, unless the nearby pixels to the upper-right of block “3b” and block “7b” are processed as unavailable, it will be difficult to decode those blocks later at the decoding end. In other words, the coding efficiency will decrease.

In contrast, in the case of the image encoding apparatus 51, the output order and the encoding order are the same, and thus the decoding order at the decoding end is also the same, and nearby pixels to the upper-right of block “3b” and block “7b” can be processed as available. In other words, the number of candidate intra prediction modes increases.

Thus, in the image encoding apparatus 51 it is possible to realize pipeline processing and parallel processing with high coding efficiency, and without causing decreased coding efficiency.

### [Description of Encoding Process in Image Encoding Apparatus]

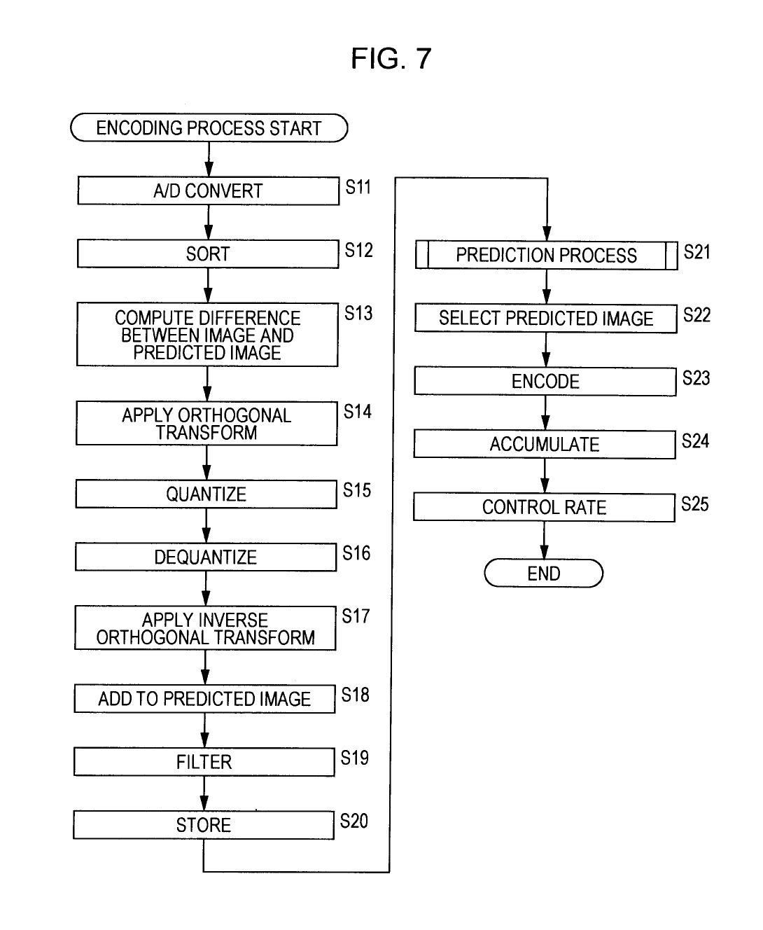

Next, an encoding process in the image encoding apparatus 51 in FIG. 3 will be described with reference to the flowchart in FIG. 7.

In a step S11, the A/D converter 61 A/D converts input images. In a step S12, the frame sort buffer 62 stores images supplied by the A/D converter 61, and sorts them from the order in which to display individual pictures into the order in which to encode.

In a step S13, the arithmetic unit 63 computes the difference between an image sorted in step S12 and a predicted image. The predicted image is supplied to the arithmetic unit 63 via the predicted image selector 78, and is supplied from the motion prediction/compensation unit 77 in the case of inter predicting, or from the intra prediction unit 74 in the case of intra predicting.

The difference data has a smaller data size compared to the original image data. Consequently, the data size can be compressed compared to the case of encoding an image directly.

In a step S14, the orthogonal transform unit 64 applies an orthogonal transform to difference information supplied from the arithmetic unit 63. Specifically, an orthogonal transform such as the discrete cosine transform or the Karhunen-Loeve transform is applied, and transform coefficients are output. In a step S15, the quantizer 65 quantizes the transform coefficients. During this quantization the rate is controlled, as described in the processing in a step S25 later discussed.

The difference information that has been quantized in this way is locally decoded as follows. Namely, in a step S16, the dequantizer 68 dequantizes transform coefficients that have been quantized by the quantizer 65, with characteristics corresponding to the characteristics of the quantizer 65. In a step S17, the inverse orthogonal transform unit 69 applies an inverse orthogonal transform to transform coefficients that have been reverse quantized by the dequantizer 68, with characteristics corresponding to the characteristics of the orthogonal transform unit 64.

In a step S18, the arithmetic unit 70 adds a predicted image input via the predicted image selector 78 to locally decoded difference information, and generates a locally decoded image (an image corresponding to the input into the arithmetic unit 63). In a step S19, the deblocking filter 71 filters an image output by the arithmetic unit 70. In so doing, blocking artifacts are removed. In a step S20, the frame memory 72 stores the filtered image. Meanwhile, an image that has not been filtered by the deblocking filter 71 is also supplied from the arithmetic unit 70 to the frame memory 72 and stored.

In a step S21, the intra prediction unit 74 and the motion prediction/compensation unit 77 respectively conduct an image prediction process. In other words, in step S21, the intra prediction unit 74 conducts an intra prediction process in intra prediction modes, while the motion prediction/compensation unit 77 conducts a motion prediction/compensation process in inter prediction modes.

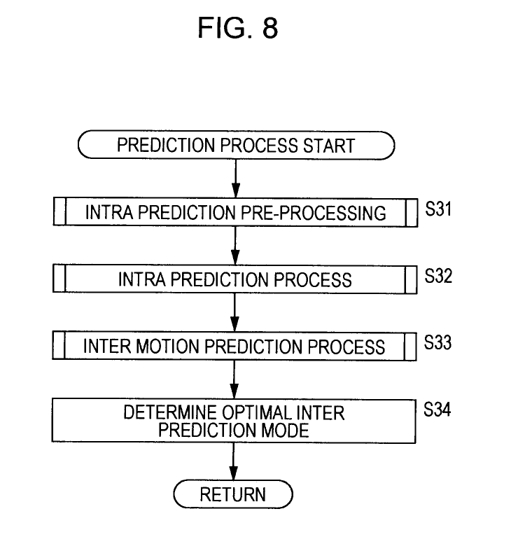

Details of the prediction process in step S21 will be discussed later with reference to FIG. 8, but as a result of this process, a prediction process is respectively conducted in all prediction modes given as candidates, and a cost function value is respectively computed for all prediction modes given as candidates. Then, the optimal intra prediction mode is selected on the basis of the computed cost function values, and the predicted image generated by intra prediction in the optimal intra prediction mode and its cost function value are supplied to the predicted image selector 78.

Meanwhile, the optimal inter prediction mode from among the inter prediction modes is determined on the basis of the computed cost function values, and the predicted image generated in the optimal inter prediction mode and its cost function value are supplied to the predicted image selector 78.

In a step S22, the predicted image selector 78 determines the optimal prediction mode from between the optimal intra prediction mode and the optimal inter prediction mode, on the basis of their respective cost function values output by the intra prediction unit 74 and the motion prediction/compensation unit 77. Then, the predicted image selector 78 selects the predicted image of the optimal prediction mode thus determined, and supplies it to the arithmetic units 63 and 70. As discussed earlier, this predicted image is used in the computation in steps S13 and S18.

Herein, this predicted image selection information is supplied to the intra prediction unit 74 or the motion prediction/compensation unit 77. In the case where the predicted image of the optimal intra prediction mode is selected, the intra prediction unit 74 supplies information indicating the optimal intra prediction mode (or in other words, intra prediction mode information) to the lossless encoder 66.

In the case where the predicted image of the optimal inter prediction mode is selected, the motion prediction/compensation unit 77 outputs information indicating the optimal inter prediction mode, and if necessary, information that depends on the optimal inter prediction mode, to the lossless encoder 66. Motion vector information, flag information, and reference frame information, etc. may be cited as information that depends on the optimal inter prediction mode. In other words, when a predicted image given by an inter prediction mode taken to be the optimal inter prediction mode is selected, the motion prediction/compensation unit 77 outputs inter prediction mode information, motion vector information, and reference frame information to the lossless encoder 66.

In a step S23, the encoding processor 81 encodes quantized transform coefficients output by the quantizer 65. In other words, a difference image is losslessly encoded and compressed by variable-length encoding or arithmetic coding, etc. At this point, the intra prediction mode information from the intra prediction unit 74 or the information that depends on the optimal inter prediction mode from the motion prediction/compensation unit 77, etc. that was input into the encoding processor 81 in step S22 discussed above is also encoded and added to the header information.

Data encoded by the encoding processor 81 is output by the stream output unit 82 to the accumulation buffer 67 as a stream in an output order that is the same as the encoding order.

In a step S24, the accumulation buffer 67 stores a difference image as a compressed image. Compressed images stored in the accumulation buffer 67 are read out as appropriate and transmitted to a decoder via a transmission path.

In a step S25, the rate controller 79 controls the rate of quantization operations by the quantizer 65 such that overflow or underflow does not occur, on the basis of compressed images stored in the accumulation buffer 67.

### [Description of Prediction Process]

Next, the prediction process in step S21 of FIG. 7 will be described with reference to the flowchart in FIG. 8.

In the case where the image to be processed that is supplied from the frame sort buffer 62 is an image of blocks to be intra processed, already-decoded images to be referenced are read out from the frame memory 72 and supplied to the intra prediction unit 74 via the switch 73.

The intra prediction unit 74 supplies the address controller 75 with information on the next processing number, which indicates which block or blocks in a macroblock are to be processed next.

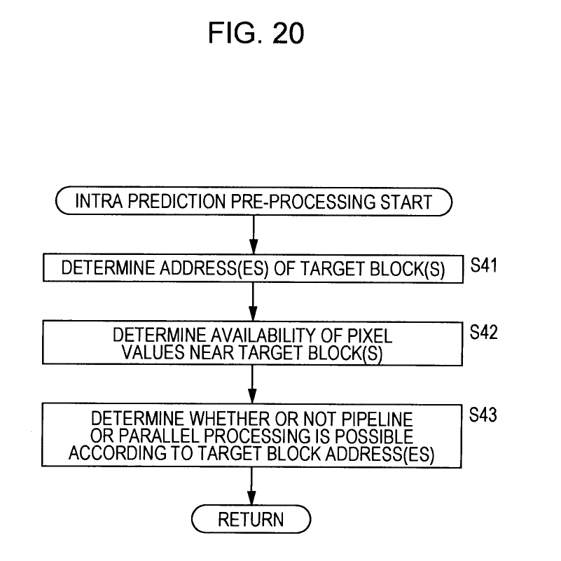

In a step S31, the address controller 75 and the nearby pixel availability determination unit 76 conduct intra prediction pre-processing. Details of the intra prediction pre-processing in step S31 will be discussed later with reference to FIG. 20.

As a result of this process, block addresses are determined for one or more blocks which correspond to the processing number and which are to be processed next in the processing order illustrated in A of FIG. 2. Also, the determined one or more block addresses are used to determine whether or not pipeline processing or parallel processing of target blocks is possible, and to determine the availability of pixels near the one or more target blocks. Then, the block addresses of the one or more blocks to be processed next, a control signal that controls or forbids pipeline processing or parallel processing, and information indicating the availability of nearby pixels are supplied to the intra prediction unit 74.

In a step S32, the intra prediction unit 74 uses supplied images to intra predict pixels in one or more processing target blocks in all intra prediction modes given as candidates. Herein, pixels which have not been filtered by the deblocking filter 71 are used as already-decoded pixels to be referenced.

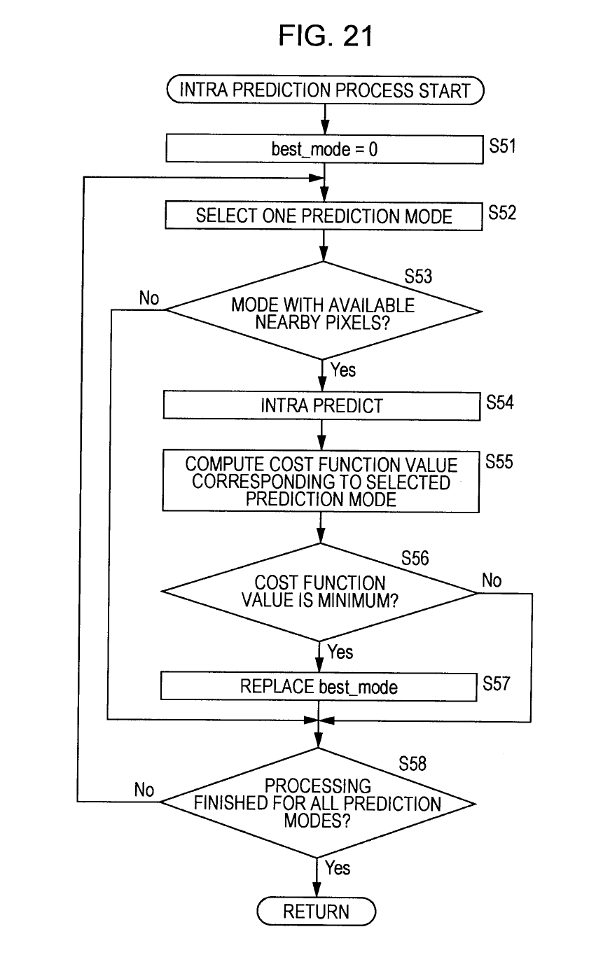

Details of the intra prediction in step S32 will be discussed later with reference to FIG. 21, but as a result of this process, intra prediction is conducted in all intra prediction modes given as candidates. Furthermore, at this point the intra prediction unit 74 conducts an intra prediction process on one or more target blocks corresponding to one or more block addresses determined by the address controller 75 in intra prediction modes that use nearby pixels determined to be available by the nearby pixel availability determination unit 76. At this point, the intra prediction unit 74 conducts intra prediction on those blocks by pipeline processing or parallel processing at this point in the case where a control signal that controls pipeline processing or parallel processing has been received from the address controller 75.

Then, cost function values are computed for all intra prediction modes given as candidates, and the optimal intra prediction mode is determined on the basis of the computed cost function values. A generated predicted image and the cost function value of the optimal intra prediction mode are supplied to the predicted image selector 78.

In the case where the image to be processed that is supplied from the frame sort buffer 62 is an image to be inter processed, images to be referenced are read out from the frame memory 72 and supplied to the motion prediction/compensation unit 77 via the switch 73. On the basis of these images, the motion prediction/compensation unit 77 conducts an inter motion prediction process in a step S33. In other words, the motion prediction/compensation unit 77 references images supplied from the frame memory 72 and conducts a motion prediction process in all inter prediction modes given as candidates.

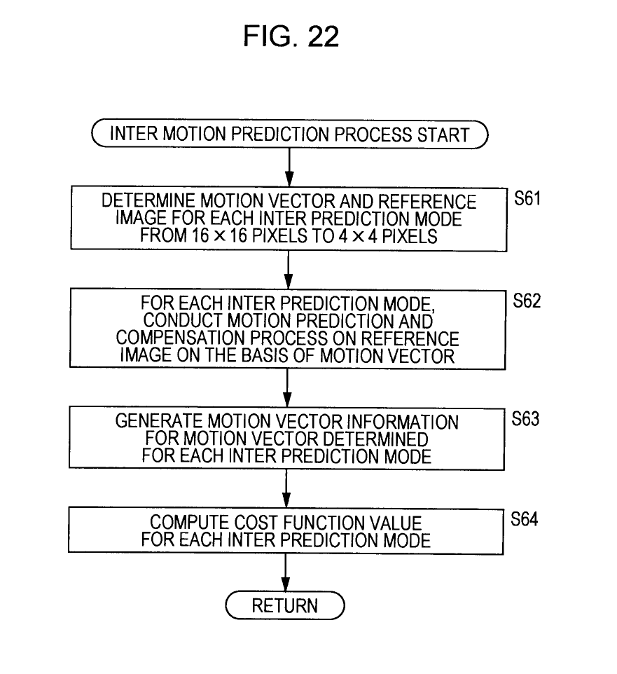

Details of the inter motion prediction process in step S33 will be discussed later with reference to FIG. 22, but as a result of this process, a motion prediction process is conducted in all inter prediction modes given as candidates, and a cost function value is computed for all inter prediction modes given as candidates.

In a step S34, the motion prediction/compensation unit 77 compares the cost function values for the inter prediction modes computed in step S33 and determines the optimal inter prediction mode to be the prediction mode that gives the minimum value. Then, the motion prediction/compensation unit 77 supplies the predicted image generated with the optimal inter prediction mode and its cost function value to the predicted image selector 78.

### [Description of Intra Prediction Process in the H.264/AVC Format]

Next, respective intra prediction modes defined in the H.264/AVC format will be described.

First, intra prediction modes for luma signals will be described. Three types of techniques are defined as intra prediction modes for luma signals: intra 4×4 prediction modes, intra 8×8 prediction modes, and intra 16×16 prediction modes. These are modes defining block units, and are set on a per-macroblock basis. It is also possible to set intra prediction modes for chroma signals independently of luma signals on a per-macroblock basis.

Furthermore, in the case of the intra 4×4 prediction modes, one prediction mode from among nine types of prediction modes can be set for each 4×4 pixel target block. In the case of the intra 8×8 prediction modes, one prediction mode from among nine types of prediction modes can be set for each 8×8 pixel target block. Also, in the case of the intra 16×16 prediction modes, one prediction mode from among four types of prediction modes can be set for a 16×16 pixel target block.

However, the intra 4×4 prediction modes, the intra 8×8 prediction modes, and the intra 16×16 prediction modes will also be respectively designated 4×4 pixel intra prediction modes, 8×8 pixel intra prediction modes, and 16×16 pixel intra prediction modes hereinafter as appropriate.

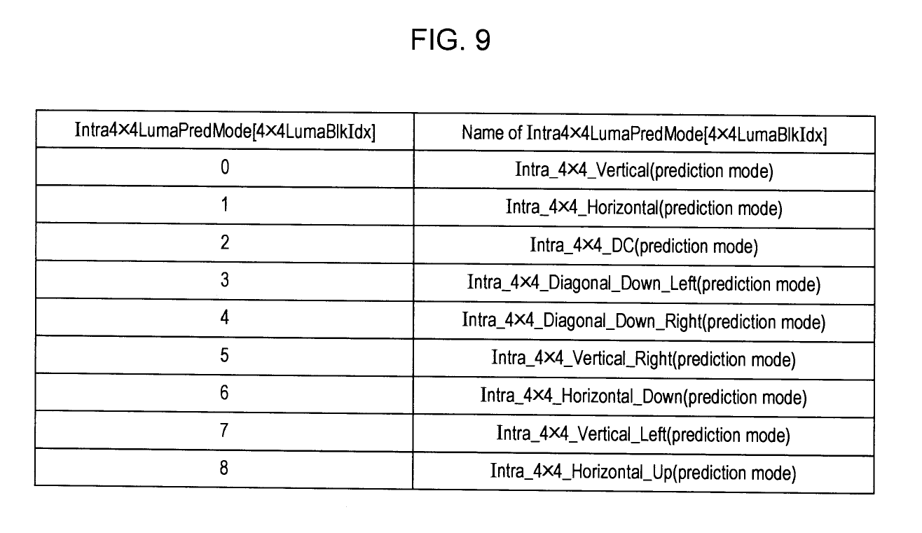

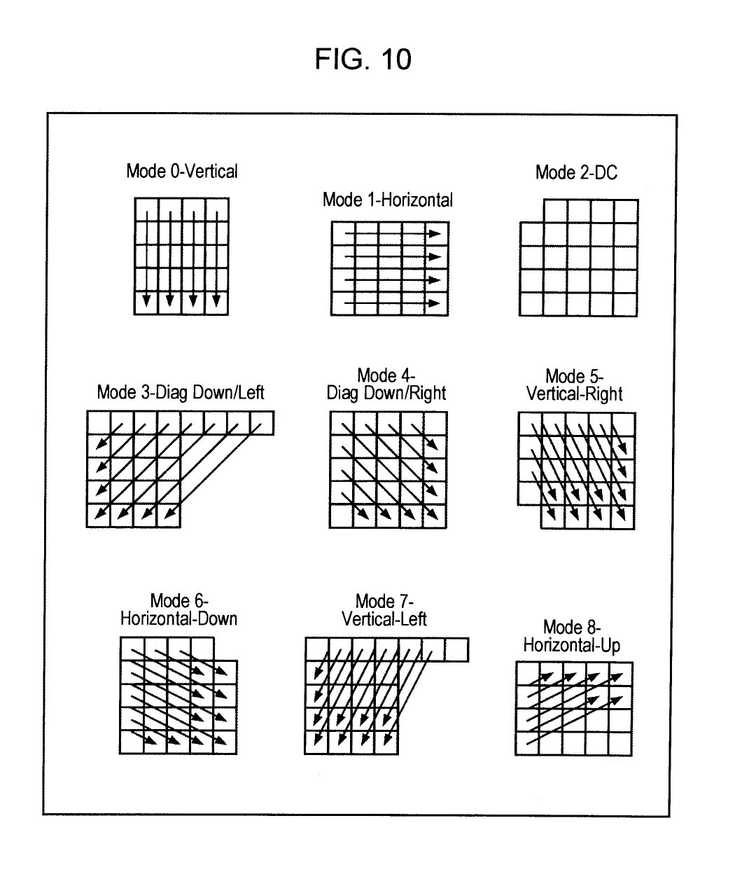

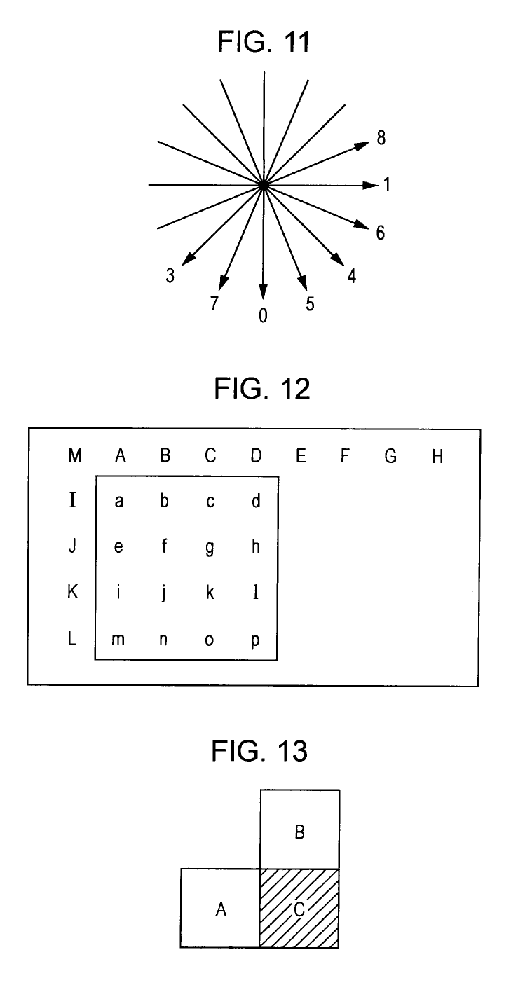

FIGS. 9 and 10 are diagrams illustrating nine types of 4×4 pixel intra prediction modes for luma signals (Intra_{—}4×4_pred_mode). The eight respective modes other than the mode indicating average value (DC) prediction each correspond to directions illustrated by the numbers 0, 1, and 3 to 8 in FIG. 11.

The nine types of Intra_{—}4×4_pred_mode modes will be described with reference to FIG. 12. In the example in FIG. 12, pixels a to p represent pixels in a target block to be intra processed, while pixel values A to M represent the pixel values of pixel belonging to adjacent blocks. In other words, the pixels a to p are an image to be processed that has been read out from the frame sort buffer 62, while the pixel values A to M are the pixel values of already-decoded images to be referenced which have been read out from the frame memory 72.

In the case of the respective intra prediction modes illustrated in FIGS. 10 and 11, predicted pixel values for the pixels a to p are generated as follows using the pixel values A to M of pixels belonging to adjacent blocks. Herein, a pixel value being available means that it can be referenced and is not at the edge of the frame or yet to be encoded. In contrast, a pixel value being unavailable means that it cannot be referenced due to being at the edge of the frame or yet to be encoded.

Mode 0 is a vertical prediction mode, and is applied only in the case where the pixel values A to D are available. In this case, predicted pixel values for the pixels a to p are generated as in the following Exp. (1).

Predicted pixel value for pixels a,e,i,m=A

Predicted pixel value for pixels b,f,j,n=B

Predicted pixel value for pixels c,g,k,o=C

Predicted pixel value for pixels d,h,l,p=D (1)

Mode 1 is a horizontal prediction mode, and is applied only in the case where the pixel values I to L are available. In this case, predicted pixel values for the pixels a to p are generated as in the following Exp. (2).

Predicted pixel value for pixels a,b,c,d=I

Predicted pixel value for pixels e,f,g,h=J

Predicted pixel value for pixels i,j,k,l=K

Predicted pixel value for pixels m,n,o,p=L (2)

Mode 2 is a DC prediction mode, and predicted pixel values are generated as in Exp. (3) when the pixel values A, B, C, D, I, J, K, and L are all available.

(A+B+C+D+I+J+K+L+4)>>3 (3)

Also, predicted pixel values are generated as in Exp. (4) when the pixel values A, B, C, and D are all unavailable.

(I+J+K+L+2)>>2 (4)

Also, predicted pixel values are generated as in Exp. (5) when the pixel values I, J, K, and L are all unavailable.

(A+B+C+D+2)>>2 (5)

Meanwhile, 128 is used as the predicted pixel value when the pixel values A, B, C, D, I, J, K, and L are all unavailable.

Mode 3 is a diagonal down-left prediction mode, and is applied only in the case where the pixel values A, B, C, D, I, J, K, L, and M are available. In this case, predicted pixel values for the pixels a to p are generated as in the following Exp. (6).

Predicted pixel value for pixel a=(A+2B+C+2)>>2

Predicted pixel value for pixels b,e=(B+2C+D+2)>>2

Predicted pixel value for pixels c,f,i=(C+2D+E+2)>>2

Predicted pixel value for pixels d,g,j,m=(D+2E+F+2)>>2

Predicted pixel value for pixels h,k,n=(E+2F+G+2)>>2

Predicted pixel value for pixels l,o=(F+2G+H+2)>>2

Predicted pixel value for pixel p=(G+3H+2)>>2 (6)

Mode 4 is a diagonal down-right prediction mode, and is applied only in the case where the pixel values A, B, C, D, I, J, K, L, and M are available. In this case, predicted pixel values for the pixels a to p are generated as in the following Exp. (7).

Predicted pixel value for pixel m=(J+2K+L+2)>>2

Predicted pixel value for pixels i,n=(I+2J+K+2)>>2

Predicted pixel value for pixels e,j,o=(M+2I+J+2)>>2

Predicted pixel value for pixels a,f,k,p=(A+2M+I+2)>>2

Predicted pixel value for pixels b,g,l=(M+2A+B+2)>>2

Predicted pixel value for pixels c,h=(A+2B+C+2)>>2

Predicted pixel value for pixel d=(B+2C+D+2)>>2 (7)

Mode 5 is a diagonal vertical-right prediction mode, and is applied only in the case where the pixel values A, B, C, D, I, J, K, L, and M are available. In this case, predicted pixel values for the pixels a to p are generated as in the following Exp. (8).

Predicted pixel value for pixels a,j=(M+A+1)>>1

Predicted pixel value for pixels b,k=(A+B+1)>>1

Predicted pixel value for pixels c,l=(B+C+1)>>1

Predicted pixel value for pixel d=(C+D+1)>>1

Predicted pixel value for pixels e,n=(I+2M+A+2)>>2

Predicted pixel value for pixels f,o=(M+2A+B+2)>>2

Predicted pixel value for pixels g,p=(A+2B+C+2)>>2

Predicted pixel value for pixel h=(B+2C+D+2)>>2

Predicted pixel value for pixel i=(M+2I+J+2)>>2

Predicted pixel value for pixel m=(I+2J+K+2)>>2 (8)

Mode 6 is a horizontal-down prediction mode, and is applied only in the case where the pixel values A, B, C, D, I, J, K, L, and M are available. In this case, predicted pixel values for the pixels a to p are generated as in the following Exp. (9).

Predicted pixel value for pixels a,g=(M+I+1)>>1

Predicted pixel value for pixels b,h=(I+2M+A+2)>>2

Predicted pixel value for pixel c=(M+2A+B+2)>>2

Predicted pixel value for pixel d=(A+2B+C+2)>>2

Predicted pixel value for pixels e,k=(I+J+1)>>1

Predicted pixel value for pixels f,l=(M+2I+J+2)>>2

Predicted pixel value for pixels i,o=(J+K+1)>>1

Predicted pixel value for pixel j,p=(I+2J+K+2)>>2

Predicted pixel value for pixel m=(K+L+1)>>1

Predicted pixel value for pixel n=(J+2K+L+2)>>2 (9)

Mode 7 is a vertical-left prediction mode, and is applied only in the case where the pixel values A, B, C, D, I, J, K, L, and M are available. In this case, predicted pixel values for the pixels a to p are generated as in the following Exp. (10).

Predicted pixel value for pixel a=(A+B+1)>>1

Predicted pixel value for pixels b,i=(B+C+1)>>1

Predicted pixel value for pixels c,j=(C+D+1)>>1

Predicted pixel value for pixels d,k=(D+E+1)>>1

Predicted pixel value for pixel l=(E+F+1)>>1

Predicted pixel value for pixel e=(A+2B+C+2)>>2

Predicted pixel value for pixels f,m=(B+2C+D+2)>>2

Predicted pixel value for pixels g,n=(C+2D+E+2)>>2

Predicted pixel value for pixels h,o=(D+2E+F+2)>>2

Predicted pixel value for pixel p=(E+2F+G+2)>>2 (10)

Mode 8 is a horizontal-up prediction mode, and is applied only in the case where the pixel values A, B, C, D, I, J, K, L, and M are available. In this case, predicted pixel values for the pixels a to p are generated as in the following Exp. (11).

Predicted pixel value for pixel a=(I+J+1)>>1

Predicted pixel value for pixel b=(I+2J+K+2)>>2

Predicted pixel value for pixels c,e=(J+K+1)>>1

Predicted pixel value for pixels d,f=(J+2K+L+2)>>2

Predicted pixel value for pixels g,i=(K+L+1)>>1

Predicted pixel value for pixels h,j=(K+3L+2)>>2

Predicted pixel value for pixels k,l,m,n,o,p=L (11)

Next, encoding formats of the 4×4 pixel intra prediction modes (Intra_{—}4×4_pred_mode) for luma signals will be described with reference to FIG. 13. The example in FIG. 13 illustrates a target block C to be encoded which consists of 4×4 pixels, as well as a block A and a block B consisting of 4×4 pixels and adjacent to the target block C.

In this case, a high correlation between the Intra_{—}4×4_pred_mode modes in the target block C and the Intra_{—}4×4_pred_mode modes in block A and block B is conceivable. By using this correlation to encode as follows, a higher coding efficiency can be realized.

Namely, in the example in FIG. 13, the Intra_{—}4×4_pred_mode modes for the block A and the block B are taken to be Intra_{—}4×4_pred_modeA and Intra_{—}4×4_pred_modeB, respectively, with a MostProbableMode defined as in the following Exp. (12).

MostProbableMode=Min(Intra_{—}4×4_pred_modeA,Intra_{—}4×4_pred_modeB) (12)

In other words, between the block A and the block B, the one assigned with the smaller mode_number is taken to be the MostProbableMode.

In a bitstream, two values called prev_intra4×4_pred_mode_flag[luma4×4BlkIdx] and rem_intra4×4_pred_mode[luma4×4BlkIdx] are defined as parameters for the target block C. Decoding is conducted by processing based on pseudo-code illustrated in the following Exp. (13), and the values of Intra_{—}4×4_predmode and Intra4×4PredMode[luma4×4BlkIdx] are obtained for the target block C.

if(prev_intra4x4_pred_mode_flag[luma4x4BlkIdx])

Intra4x4PredMode[luma4x4BlkIdx]=MostProbableMode

else

if(rem_intra4x4_pred_mode[luma4x4BlkIdx] <

MostProbableMode)

Intra4x4PredMode[luma4x4BlkIdx] =

rem_intra4x4_pred_mode[luma4x4BlkIdx]

else

Intra4x4PredMode[luma4x4BlkIdx] =

rem_intra4x4_pred_mode[luma4x4BlkIdx] + 1

(13)

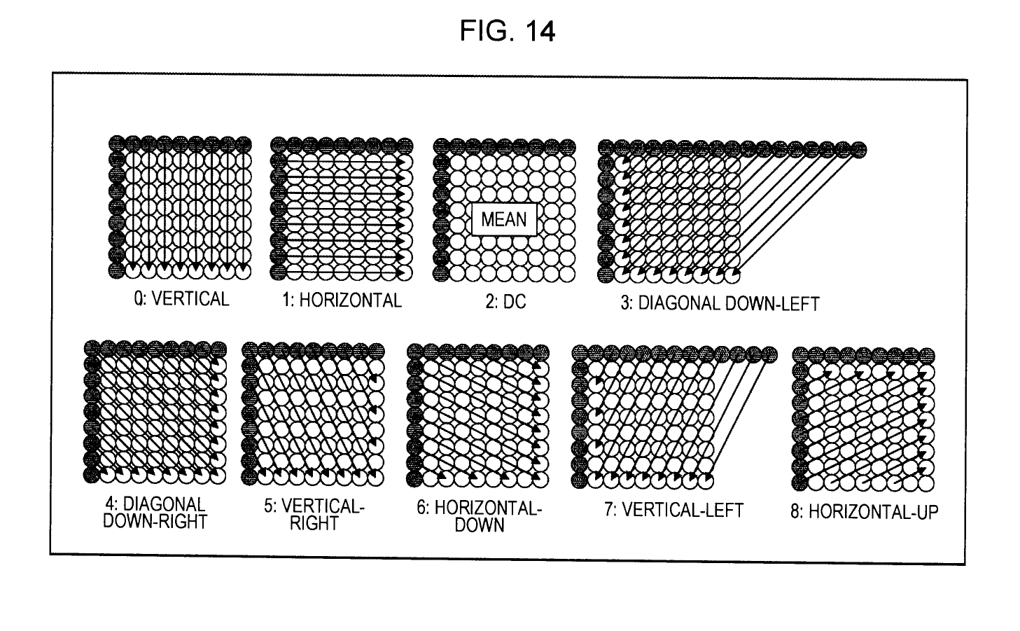

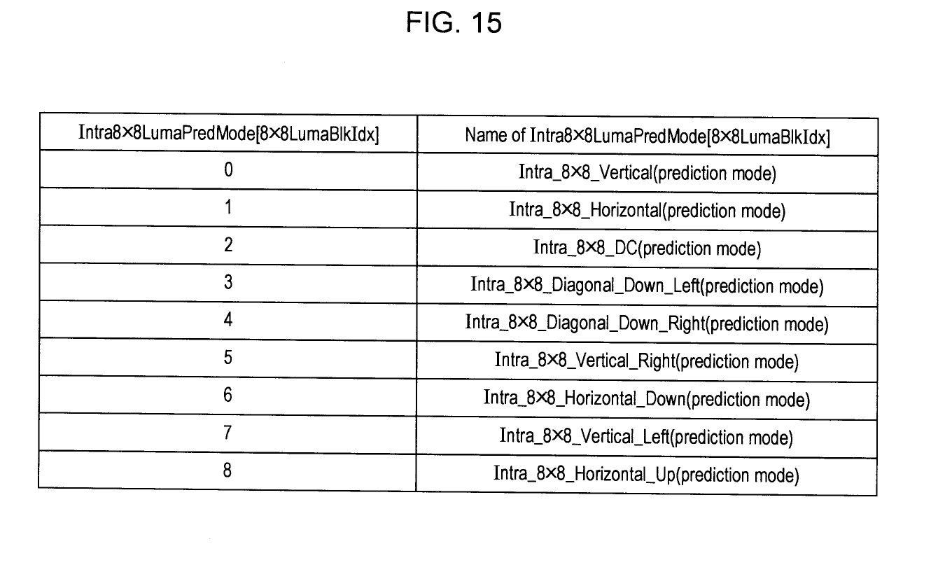

Next, 8×8 pixel intra prediction modes will be described. FIGS. 14 and 15 are diagrams illustrating nine types of 8×8 pixel intra prediction modes for luma signals (Intra_{—}8×8_pred_mode).

Take pixel values in a target 8×8 block to be expressed as p[x,y](0≦x≦7; 0≦y≦7), and pixel values in adjacent blocks to be expressed as p[−1,−1], . . . , p[−1,15], p[−1,0], . . . , [p−1,7].

For 8×8 pixel intra prediction modes, a low-pass filter is applied to adjacent pixels prior to generating predicted values. Herein, take pixel values before applying a low-pass filter to be expressed as p[−1,−1], . . . , p[−1,15], p[−1,0], . . . , p[−1,7], and pixel values after applying a low-pass filter to be expressed as p′[−1,−1], p′[−1,15], p′[−1,0], . . . , p′[−1,7].

First, p′[0,−1] is computed as in the following Exp. (14) in the case where p[−1,−1] is available, and is computed as in the following Exp. (15) in the case where it is not available.

p′[0,−1]=(p[−1,−1]+2*p[0,−1]+p[1,−1]+2)>>2 (14)

p′[0,−1]=(3*p[0,−1]+p[1,−1]+2)>>2 (15)

p′[x,−1] (for x=0 to 7) is computed as in the following Exp. (16).

p′[x,−1]=(p[x−1,−1]+2*p[x,−1]+p[x+1,−1]+2)>>2 (16)

p′[x,−1] (for x=8 to 15) is computed as in the following Exp. (17) in the case where p[x,−1] (for x=8 to 15) is available.

p′[x,−1]=(p[x−1,−1]+2*p[x,−1]+p[x+1,−1]+2)>>2

p′[15,−1]=(p[14,−1]+3*p[15,−1]+2)>>2 (17)

p′[−1,−1] is computed as follows in the case where p[−1,−1] is available. Namely, p′[−1,−1] is computed as in Exp. (18) in the case where both p[0,−1] and p[−1,0] are available, and is computed as in Exp. (19) in the case where p[−1,0] is unavailable. Also, p′[−1,−1] is computed as in Exp. (20) in the case where p[0,−1] is unavailable.

p′[−1,−1]=(p[0,−1]+2*p[−1,−1]+p[1,0]+2)>>2 (18)

p′[−1,−1]=(3*p[−1,−1]+p[0,−1]+2)>>2 (19)

p′[−1,−1]=(3*p[−1,−1]+p[−1,0]+2)>>2 (20)

p′[−1,y] (for y=0 to 7) is computed as follows when p[−1,y] (for y=0 to 7) is available. Namely, first p′[−1,0] is computed as in the following Exp. (21) in the case where p[−1,−1] is available, and is computed as in Exp. (22) in the case where it is unavailable.

p′[−1,0]=(p[−1,−1]+2*p[−1,0]+p[−1,1]+2)>>2 (21)

p′[−1,0]=(3*p[−1,0]+p[−1,1]+2)>>2 (22)

Also, p′[−1,y] (for y=1 to 6) is computed as in the following Exp. (23), and p′[−1,7] is computed as in Exp. (24).

p′[−1,y]=(p[−1,y−1]+2*p[−1,y]+p[−1,y+1]+2)>>2 (23)

p′[−1,7]=(p[−1,6]+3*p[−1,7]+2)>>2 (24)

Using p′ computed in this way, predicted values in the respective intra prediction modes illustrated in FIGS. 14 and 15 are generated as follows.

Mode 0 is a vertical prediction mode, and is applied only when p[x,−1] (for x=0 to 7) is available. A predicted value pred8×8_{L}[x,y] is generated as in the following Exp. (25).

pred8×8_{L}[x,y]=p′[x,−1] for x,y=0 to 7 (25)

Mode 1 is a horizontal prediction mode, and is applied only when p[−1,y] (for y=0 to 7) is available. A predicted value pred8×8_{L}[x,y] is generated as in the following Exp. (26).

pred8×8_{L}[x,y]=p′[−1,y] for x,y=0 to 7 (26)

Mode 2 is a DC prediction mode, and a predicted value pred8×8_{L}[x,y] is generated as follows. Namely, a predicted value pred8×8_{L}[x,y] is generated as in the following Exp. (27) in the case where both p[x,−1] (for x=0 to 7) and p[−1,y] (for y=0 to 7) are available.

$$\begin{matrix}[ Formula 1 ] & \\ Pred 8 \times {8}_{L} [ x , y ] = ( {\sum }_{{x}^{′} = 0}^{7} {P}^{′} [ {x}^{′} , - 1 ] + {\sum }_{{y}^{′} = 0}^{7} {P}^{′} [ - 1 , y ] + 8 ) >> 4 & ( 27 )\end{matrix}$$

In the case where p[x,−1] (for x=0 to 7) is available but p[−1,y] (for y=0 to 7) is unavailable, a predicted value pred8×8_{L}[x,y] is generated as in the following Exp. (28).

$$\begin{matrix}[ Formula 2 ] & \\ Pred 8 \times {8}_{L} [ x , y ] = ( {\sum }_{{x}^{′} = 0}^{7} {P}^{′} [ {x}^{′} , - 1 ] + 4 ) >> 3 & ( 28 )\end{matrix}$$

In the case where p[x,−1] (for x=0 to 7) is unavailable but p[−1,y] (for y=0 to 7) is available, a predicted value pred8×8_{L}[x,y] is generated as in the following Exp. (29).

$$\begin{matrix}[ Formula 3 ] & \\ Pred 8 \times {8}_{L} [ x , y ] = ( {\sum }_{{y}^{′} = 0}^{7} {P}^{′} [ - 1 , y ] + 4 ) >> 3 & ( 29 )\end{matrix}$$

In the case where both p[x,−1] (for x=0 to 7) and p[−1,y] (for y=0 to 7) are unavailable, a predicted value pred8×8_{L}[x,y] is generated as in the following Exp. (30).

pred8×8_{L}[x,y]=128 (30)

Note that Exp. (30) is expressing the case of 8-bit input.

Mode 3 is a diagonal down-left prediction mode, and a predicted value pred8×8_{L}[x,y] is generated as follows. Namely, the diagonal down-left prediction mode is applied only when p[x,−1] (for x=0 to 15) is available. A predicted pixel value for when x=7 and y=7 is generated as in the following Exp. (31), while other predicted pixel values are generated as in the following Exp. (32).

pred8×8_{L}[x,y]=(p′[14,−1]+3*p[15,−1]+2)>>2 (31)

pred8×8_{L}[x,y]=(p′[x+y,−1]+2*p′[x+y+1,−1]+p′[x+y+2,−1]+2)>>2 (32)

Mode 4 is a diagonal down-right prediction mode, and a predicted value pred8×8_{L}[x,y] is generated as follows. Namely, the diagonal down-right prediction mode is applied only when p[x,−1] (for x=0 to 7) and p[−1,y] (for y=0 to 7) are available. A predicted pixel value for when x>y is generated as in the following Exp. (33), and a predicted pixel value for when x<y is generated as in the following Exp. (34). Also, a predicted pixel value for when x=y is generated as in the following Exp. (35).

pred8×8_{L}[x,y]=(p′[x−y−2,−1]+2*p′[x−y−1,−1]+p′[x−y,−1]+2)>>2 (33)

pred8×8_{L}[x,y]=(p′[−1,y−x−2]+2*p′[−1,y−x−1]+p′[−1,y−x]+2)>>2 (34)

pred8×8_{L}[x,y]=(p′[0,−1]+2*p′[−1,−1]+p′[−1,0]+2)>>2 (35)

Mode 5 is a vertical-right prediction mode, and a predicted value pred8×8_{L}[x,y] is generated as follows. Namely, the vertical-right prediction mode is applied only when p[x,−1] (for x=0 to 7) and p[−1,y] (for y=−1 to 7). Herein zVR is defined as in the following Exp. (36).

zVR=2*x−y (36)

At this point, a predicted pixel value is generated as in the following Exp. (37) in the case where zVR is 0, 2, 4, 6, 8, 10, 12, or 14, whereas a predicted pixel value is generated as in the following Exp. (38) in the case where zVR is 1, 3, 5, 7, 9, 11, or 13.

pred8×8_{L}[x,y]=(p′[x−(y>>1)−1,−1]+p′[x−(y>>1),−1]+1)>>1 (37)

pred8×8_{L}[x,y]=(P′[x−(y>>1)−2,−1]+2*p′[x−(y>>1)−1,−1]+p′[x−(y>>1),−1]+2)>>2 (38)

Also, in the case where zVR is −1, a predicted pixel value is generated as in the following Exp. (39), while in all other cases, or in other words in the case where zVR is −2, −3, −4, −5, −6, or −7, a predicted pixel value is generated as in the following Exp. (40).

pred8×8_{L}[x,y]=(p′[−1,0]+2*p′[−1,−1]+p′[0,−1]+2)>>2 (39)

pred8×8_{L}[x,y]=(p′[−1,y−2*x−1]+2*p′[−1,y−2*x−2]+p′[−1,y−2*x−3]+2)>>2 (40)

Mode 6 is a horizontal-down prediction mode, and a predicted value pred8×8_{L}[x,y] is generated as follows. Namely, the horizontal-down prediction mode is applied only when p[x,−1] (for x=0 to 7) and p[−1,y] (for y=−1 to 7) are available. Herein zVR is defined as in the following Exp. (41).

zHD=2*y−x (41)

At this point, a predicted pixel value is generated as in the following Exp. (42) in the case where zHD is 0, 2, 4, 6, 8, 10, 12, or 14, whereas a predicted pixel value is generated as in the following Exp. (43) in the case where zVR is 1, 3, 5, 7, 9, 11, or 13.

pred8×8_{L}[x,y]=(p′[−1,y−(x>>1)−1]+p′[−1,y−(x>>1)]+1)>>1 (42)

pred8×8_{L}[x,y]=(p′[−1,y−(x>>1)−2]+2*p′[−1,y−(x>>1)−1]+p′[−1,y−(x>>1)]+2)>>2 (43)

Also, in the case where zHD is −1, a predicted pixel value is generated as in the following Exp. (44), while in all other cases, or in other words in the case where zHD is −2, −3, −4, −5, −6, or −7, a predicted pixel value is generated as in the following Exp. (45).

pred8×8_{L}[x,y]=(p′[−1,0]+2*p[−1,−1]+p′[0,−1]+2)>>2 (44)

pred8×8_{L}[x,y]=(p′[x−2*y−1,−1]+2*p′[x−2*y−2,−1]+p′[x−2*y−3,−1]+2)>>2 (45)

Mode 7 is a vertical-left prediction mode, and a predicted value pred8×8_{L}[x,y] is generated as follows. Namely, the vertical-left prediction mode is applied only when p[x,−1] (for x=0 to 15) is available. A predicted pixel value is generated as in the following Exp. (46) in the case where y equals 0, 2, 4, or 6, whereas a predicted value is generated as in the following Exp. (47) in all other cases, or in other words in the case where y equals 1, 3, 5, or 7.

pred8×8_{L}[x,y]=(P′[x+(y>>1),−1]+p′[x+(y>>1)+1,−1]+1)>>1 (46)

pred8×8_{L}[x,y]=(p′[x+(y>>1),−1]+2*p′[x+(y>>1)+1,−1]+p′[x+(y>>1)+2,−1]+2)>>2 (47)

Mode 8 is a horizontal-up prediction mode, and a predicted value pred8×8_{L}[x,y] is generated as follows. Namely, the horizontal-up prediction mode is applied only when p[−1,y] (for y=0 to 7) is available. Hereinafter, zHU is defined as in the following Exp. (48).

zHU=x+2*y (48)

A predicted pixel value is generated as in the following Exp. (49) in the case where the values of zHU is 0, 2, 4, 6, 8, 10, or 12, whereas a predicted pixel value is generated as in the following Exp. (50) in the case where the value of zHU is 1, 3, 5, 7, 9, or 11.

pred8×8_{L}[x,y]=(p′[−1,y+(x>>1)]+p′[−1,y+(x>>1)+1]+1)>>1 (49)

pred8×8_{L}[x,y]=(p′[−1,y+(x>>1)] (50)

Also, in the case where the value of zHU is 13, a predicted pixel value is generated as in the following Exp. (49)′, while in all other cases, or in other words in the case where the value of zHU is greater than 13, a predicted pixel value is generated as in the following Exp. (50)′.

pred8×8_{L}[x,y]=(p′[−1,6]+3*p′[−1,7]+2)>>2 (49)′

pred8×8_{L}[x,y]=p′[−1,7] (50)′

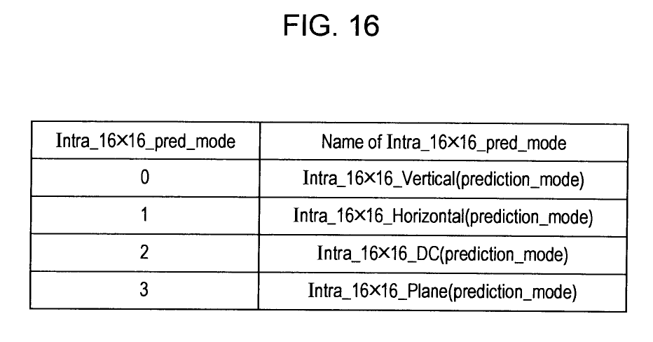

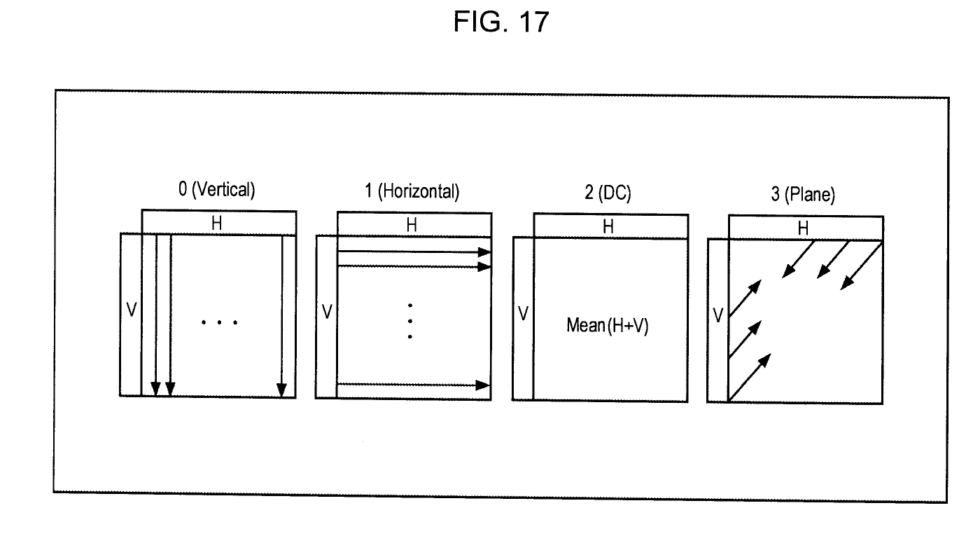

Next, 16×16 pixel intra prediction modes will be described. FIGS. 16 and 17 are diagrams illustrating four types of 16×16 pixel intra prediction modes for luma signals (Intra_{—}16×16_pred_mode).

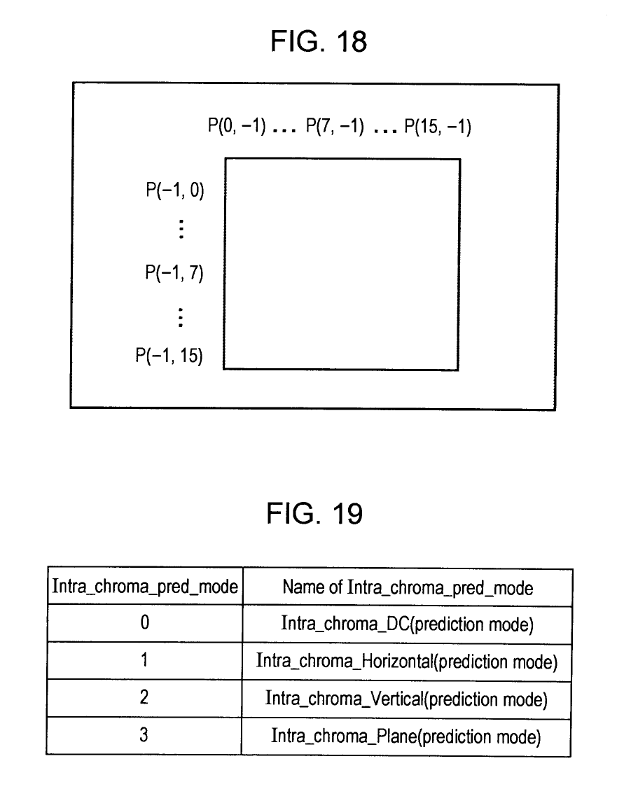

Four types of intra prediction modes will be described with reference to FIG. 18. The example in FIG. 18 illustrates a target macroblock A to be intra processing, wherein P(x,y) (for x,y=−1 to 15) represent the pixel values of pixels adjacent to the target macroblock A.

Mode 0 is a vertical prediction mode, and is applied only when P(x,−1) (for x,y=−1 to 15) is available. In this case, predicted pixel values Pred(x,y) for respective pixels in the target macroblock A are generated as in the following Exp. (51).

Pred(x,y)=P(x,−1) for x,y=0 to 15 (51)

Mode 1 is a horizontal prediction mode, and is applied only when P(−1,y) (for x,y=−1 to 15) is available. In this case, predicted pixel values Pred(x,y) for respective pixels in the target macroblock A are generated as in the following Exp. (52).

Pred(x,y)=P(−1,y) for x,y=0 to 15 (52)

Mode 2 is a DC prediction mode, and predicted pixel values Pred(x,y) for respective pixels in the target macroblock A are generated as in the following Exp. (53) in the case where P(x,−1) and P(−1,y) (for x,y=−1 to 15) are all available.

$$\begin{matrix}[ Formula 4 ] & \\ Pred ( x , y ) = [ {\sum }_{{x}^{′} = 0}^{15} P [ {x}^{′} , - 1 ] + {\sum }_{{y}^{′} = 0}^{15} P [ - 1 , {y}^{′} ] + 16 ] >> 5 \\ with x , y = 0 , … , 15 & ( 53 )\end{matrix}$$

Also, predicted pixels Pred(x,y) for respective pixels in the target macroblock A are generated as in the following Exp. (54) in the case where P(x,−1) (for x,y=−1 to 15) is unavailable.

$$\begin{matrix}[ Formula 5 ] & \\ Pred ( x , y ) = [ {\sum }_{{y}^{′} = 0}^{15} P ( - 1 , {y}^{′} ) + 8 ] >> 4 \\ with x , y = 0 , … , 15 & ( 54 )\end{matrix}$$

Predicted pixels Pred(x,y) for respective pixels in the target macroblock A are generated as in the following Exp. (55) in the case where P(−1,y) (for x,y=−1 to 15) is unavailable.

$$\begin{matrix}[ Formula 6 ] & \\ Pred ( x , y ) = [ {\sum }_{{y}^{′} = 0}^{15} P ( {x}^{′} , - 1 ) + 8 ] >> 4 \\ with x , y = 0 , … , 15 & ( 55 )\end{matrix}$$

In the case where P(x,−1) and P(−1,y) (for x,y=−1 to 15) are all unavailable, 128 is used as the predicted pixel value.

Mode 3 is a plane prediction mode, and is applied only in the case where P(x,−1) and P(−1,y) (for x,y=−1 to 15) are all available. In this case, predicted pixel values Pred(x,y) for respective pixels in the target macroblock A are generated as in the following Exp. (56).

$$\begin{matrix}[ Formula 7 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 56 )\end{matrix}$$

Next, intra prediction modes for chroma signals will be described. FIG. 19 is a diagram illustrating four types of intra prediction modes for chroma signals (Intra_chrome_pred_mode). It is possible to set intra prediction modes for chroma signals independently of intra prediction modes for luma signals. Intra prediction modes for chroma signals conform to the 16×16 pixel intra prediction modes for luma signals discussed above.

However, whereas 16×16 pixel intra prediction modes for luma signals are applied to 16×16 pixel blocks, intra prediction modes for chroma signals are applied to 8×8 pixel blocks. Additionally, the modes numbers for the two types of intra prediction modes are unrelated, as illustrated in FIGS. 16 and 19 discussed above.

The following conforms to the definitions of the pixel values and the adjacent pixel values for a target macroblock A in the 16×16 pixel intra prediction modes for luma signals discussed above with reference to FIG. 18. For example, the pixel values for pixels adjacent to a target macroblock A to be intra processed (8×8 pixels in the case of chroma signals) are taken to be P(x,y) (for x,y=−1 to 7).

Mode 0 is a DC prediction mode, and predicted pixel values Pred(x,y) for respective pixels in the target macroblock A are generated as in the following Exp. (57) in the case where P(x,−1) and P(−1,y) (for x,y=−1 to 7) are all available.

$$\begin{matrix}[ Formula 8 ] & \\ Pred ( x , y ) = ( ( {\sum }_{n = 0}^{7} ( P ( - 1 , n ) + P ( n , - 1 ) ) ) + 8 ) >> 4 \\ with x , y = 0 , … , 7 & ( 57 )\end{matrix}$$

Also, predicted pixel values Pred(x,y) for respective pixels in the target macroblock A are generated as in the following Exp. (58) in the case where P(−1,y) (for x,y=−1 to 7) is unavailable.

$$\begin{matrix}[ Formula 9 ] & \\ Pred ( x , y ) = [ ( {\sum }_{n = 0}^{7} P ( n , - 1 ) ) + 4 ] >> 3 \\ with x , y = 0 , … , 7 & ( 58 )\end{matrix}$$

Also, predicted values Pred(x,y) for respective pixels in the target macroblock A are generated as in the following Exp. (59) in the case where P(x,−1) (for x,y=−1 to 7) is unavailable.

$$\begin{matrix}[ Formula 10 ] & \\ Pred ( x , y ) = [ ( {\sum }_{n = 0}^{7} P ( - 1 , n ) ) + 4 ] >> 3 \\ with x , y = 0 , … , 7 & ( 59 )\end{matrix}$$

Mode 1 is a horizontal prediction mode, and is applied only in the case where P(−1,y) (for x,y=−1 to 7) is available). In this case, predicted values Pred(x,y) for respective pixels in the target macroblock A are generated as in the following Exp. (60).

Pred(x,y)=P(−1,y) for x,y=0 to 7 (60)

Mode 2 is a vertical prediction mode, and is applied only in the case where P(x,−1) (for x,y=−1 to 7) is available. In this case, predicted values Pred(x,y) for respective pixels in the target macroblock A are generated as in the following Exp. (61).

Pred(x,y)=P(x,−1) for x,y=0 to 7 (61)

Mode 3 is a plane prediction mode, and is applied only in the case where P(x,−1) and P(−1,y) (for x,y=−1 to 7) are available. In this case, predicted values Pred(x,y) for respective pixels in the target macroblock A are generated as in the following Exp. (62).

$$\begin{matrix}[ Formula 11 ] & \\ Pred ( x , y ) = Clip 1 ( ( a + b \cdot ( x - 3 ) + c \cdot ( y - 3 ) + 16 ) >> 5 ) ; \\ x , y = 0 , … , 7 \\ a = 16 \cdot ( P ( - 1 , 7 ) + P ( 7 , - 1 ) ) \\ b = ( 17 \cdot H + 16 ) >> 5 \\ c = ( 17 \cdot V + 16 ) >> 5 \\ H = {\sum }_{x = 1}^{4} x \cdot [ P ( 3 + x , - 1 ) - P ( 3 - x , - 1 ) ] \\ V = {\sum }_{y = 1}^{4} y \cdot [ P ( - 1 , 3 + y ) - P ( - 1 , 3 - y ) ] & ( 62 )\end{matrix}$$

As above, among intra prediction modes for luma signals, there are prediction modes with nine types of 4×4 pixel and 8×8 pixel block units, as well four types of 16×16 pixel macroblock units. Modes with these block units are set on a per-macroblock basis. Among intra prediction modes for chroma signals, there are prediction modes with four types of 8×8 pixel block units. It is possible to set these intra prediction modes for chroma signals independently of intra prediction modes for luma signals.

Also, for the 4×4 pixel intra prediction modes (intra 4×4 prediction modes) and the 8×8 pixel intra prediction modes (intra 8×8 prediction modes) for luma signals, one intra prediction mode is set for each 4×4 pixel and 8×8 pixel block in a luma signal. For the 16×16 intra prediction modes (intra 16×16 prediction modes) for luma signals and the intra prediction modes for chroma signals, one prediction mode is set for one macroblock.

Herein, the prediction mode types correspond to directions illustrated by the numbers 0, 1, and 3 to 8 in FIG. 11 discussed earlier. Prediction mode 2 is an average value prediction.

### [Description of Intra Prediction Pre-Processing]

Next, the intra prediction pre-processing in step S31 of FIG. 8 will be described with reference to the flowchart in FIG. 20.

The block address computation unit 91 is supplied with information on the next processing number, which indicates which block or blocks in a macroblock are to be processed next, from the intra prediction unit 74.

In a step S41, the block address computation unit 91 computes and determines, from the next processing number from the intra prediction unit 74, the block addresses of one or more target blocks following the processing order illustrated in A of FIG. 2. The determined one or more block addresses are supplied to the intra prediction unit 74, the pipeline/parallel processing controller 92, and the nearby pixel availability determination unit 76.

In a step S42, the nearby pixel availability determination unit 76 uses one or more block addresses from the address controller 75 to judge and determine the availability of pixels near the one or more target blocks.

In the case where a pixel near the one or more target blocks is available, the nearby pixel availability determination unit 76 supplies the intra prediction unit 74 with information indicating that a pixel near the one or more target blocks is available. Also, in the case where a pixel near the one or more target blocks is unavailable, the nearby pixel availability determination unit 76 supplies the intra prediction unit 74 with information indicating that a pixel near the one or more target blocks is unavailable.

In a step S43, the pipeline/parallel processing controller 92 uses one or more block addresses from the block address computation unit 91 to determine whether or not pipeline processing or parallel processing of target blocks is possible.

In other words, in the case where pipeline processing or parallel processing of target blocks is possible, such as with block “2a” and block “2b” in A of FIG. 2, for example, the pipeline/parallel processing controller 92 supplies the intra prediction unit 74 with a control signal that controls pipeline processing or parallel processing.

Also, in the case where pipeline processing or parallel processing of target blocks is not possible, such as with block “1” or block “8” in A of FIG. 2, for example, the pipeline/parallel processing controller 92 supplies the intra prediction unit 74 with a control signal that forbids pipeline processing or parallel processing.

### [Description of Intra Prediction Process]

Next, an intra prediction process conducted using information computed by the pre-processing discussed above will be described with reference to the flowchart in FIG. 21.

The intra prediction process herein is the intra prediction process in step S32 of FIG. 8, and in the example in FIG. 21, the case of a luma signal is described as an example. Also, this intra prediction process is a process conducted individually on each target block. In other words, the process in FIG. 21 is conducted by pipeline processing or parallel processing in the case where a control signal that controls pipeline processing or parallel processing is supplied to the intra prediction unit 74 from the pipeline/parallel processing controller 92 as a result of pre-processing discussed earlier with reference to FIG. 20.

In a step S51, the intra prediction unit 74 resets the optimal prediction mode (best_mode=0) for the target block.

In a step S52, the intra prediction unit 74 selects a prediction mode. In the case of intra 4×4 prediction modes, there are nine types of prediction modes as discussed earlier with reference to FIG. 9, and from among them one prediction mode is selected.

In a step S53, the intra prediction unit 74 references information indicating the availability of pixels near the target block which has been supplied from the nearby pixel availability determination unit 76, and determines whether or not the selected prediction mode is a mode with available pixels near the target block.

The process proceeds to a step S54 in the case where it is determined that the selected predicted mode is a mode with available pixels near the target block. In step S54, the intra prediction unit 74 references pixels in the target block and already-decoded adjacent images read out from the frame memory 72 to intra predict in the selected prediction mode. Herein, pixels which have not been filtered by the deblocking filter 71 are used as the already-decoded pixels to be referenced.

In a step S55, the intra prediction unit 74 computes a cost function value corresponding to the selected prediction mode. At this point, computation of a cost function value is conducted on the basis of either a high-complexity mode or a low-complexity mode technique. These modes are defined in the JM (Joint Model), the reference software in the H.264/AVC format.

In other words, in the high-complexity mode, the processing in step S54 involves provisionally conducting the encoding process in all prediction modes given as candidates. Additionally, a cost function value expressed by the following Exp. (63) is computed for each prediction mode, and the prediction mode that gives the minimum value is selected as the optimal prediction mode.

Cost(Mode)=D+λ·R (63)

D is the difference (distortion) between the original image and the decoded image, R is the bit rate including the orthogonal transform coefficients, and λ is the Lagrange multiplier given as a function of a quantization parameter QP.

Meanwhile, in the low-complexity mode, the processing in step S41 involves generating a predicted image and computing header bits such as motion vector information, prediction mode information, and flag information for all prediction modes given as candidates. Additionally, a cost function value expressed by the following Exp. (64) is computed for each prediction mode, and the prediction mode that gives the minimum value is selected as the optimal prediction mode.

Cost(Mode)=D+QPtoQuant(QP)·Header_Bit (64)

D is the difference (distortion) between the original image and decoded image, Header_Bit is the number of header bits for the prediction mode, and QPtoQuant is a function given as a function of a quantization parameter QP.

In the low-complexity mode, since only predicted images are generated in all prediction modes and it is not necessary to conduct an encoding process and a decoding process, computation is reduced.

Meanwhile, SAD (sum of absolute differences) may also be used as the cost function.

In a step S56, the intra prediction unit 74 determines whether or not the computed cost function is the minimum, and in the case of being determined the minimum, the selected predicted mode replaces the optimal prediction mode in a step S57. After that, the process proceeds to a step S58. Also, in the case where it is determined that the computed cost function value is not the minimum among those computed up to this point, the process in step S57 is skipped, and the process proceeds to step S58.

Meanwhile, in the case where it is determined in step S53 that the selected prediction mode is not a mode with available pixels near the target block, the process skips steps S54 to S57, and proceeds to step S58.

In step S58, the intra prediction unit 74 determines whether or not processing has finished in all nine types of prediction modes, and in the case where it is determined that processing has finished in all prediction modes, the intra prediction process ends.

In the case where it is determined in step S58 that processing has not yet finished in all prediction modes, the process returns to step S52, and the processing thereafter is repeated.

Herein, in the example in FIG. 21, 4×4 pixel intra prediction modes are described by way of example, but this intra prediction process is conducted in the respective 4×4 pixel, 8×8 pixel, and 16×16 pixel intra prediction modes. In other words, in practice, the process in FIG. 21 is also separately conducted in the respective 8×8 pixel and 16×16 pixel intra prediction modes, and the optimal intra prediction mode is additionally determined from among the respectively computed optimal prediction modes (best_mode).

Then, the predicted image of the optimal prediction mode thus determined and its cost function are supplied to the predicted image selector 78.

### [Description of Inter Motion Prediction Process]

Next, the inter motion prediction process in step S33 of FIG. 8 will be described with reference to the flowchart in FIG. 22.

In a step S61, the motion prediction/compensation unit 77 respectively determines motion vectors and reference images for each of the eight types of inter prediction modes consisting of from 16×16 pixels to 4×4 pixels.

In a step S62, the motion prediction/compensation unit 77 conducts a motion prediction and compensation process on reference images on the basis of the motion vectors determined in step S61, in each of the eight types of inter prediction modes consisting of from 16×16 pixels to 4×4 pixels. As a result this motion prediction and compensation process, a predicted image is generated in each inter prediction mode.

In a step S63, the motion prediction/compensation unit 77 generates motion vector information to add to compressed images for the motion vectors determined in each of the eight types of inter prediction modes consisting of from 16×16 pixels to 4×4 pixels. At this point, a method is used wherein predicted motion vector information for the target block to be encoded is generated by a median operation using the motion vector information of an already-encoded, adjacent block.

The generated motion vector information is also used when computing cost function values in a following step S64, and in the case where the corresponding predicted image is ultimately selected by the predicted image selector 78, is output to the lossless encoder 66 together with prediction mode information and reference frame information.

In step S64, the motion prediction/compensation unit 77 computes the cost function value expressed in Exp. (63) or Exp. (64) discussed earlier for each of the eight types of inter prediction modes consisting of from 16×16 pixels to 4×4 pixels. The cost function values computed at this point are used when determining the optimal inter prediction mode in step S34 of FIG. 8 discussed earlier.

A compressed image thus encoded is transmitted via a given transmission path and decoded by an image decoding apparatus.

### [Exemplary Configuration of Image Decoding Apparatus]

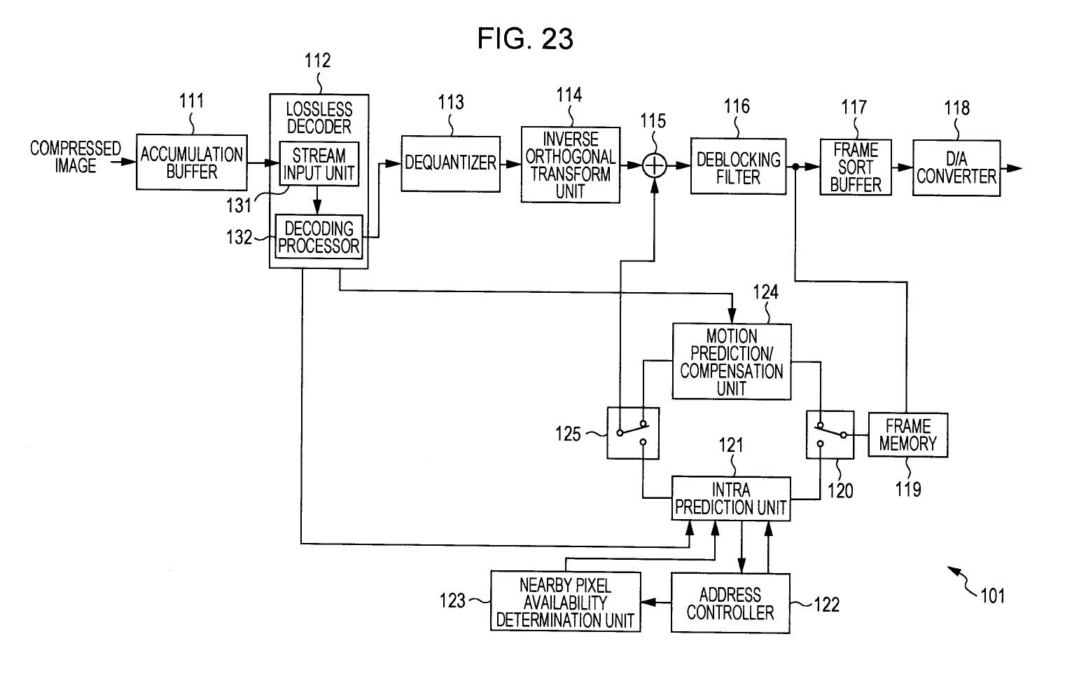

FIG. 23 illustrates a configuration of an embodiment of an image decoding apparatus as an image processing apparatus to which the present invention has been applied.

An image decoding apparatus 101 is composed of an accumulation buffer 111, a lossless decoder 112, a dequantizer 113, an inverse orthogonal transform unit 114, an arithmetic unit 115, a deblocking filter 116, a frame sort buffer 117, and a D/A converter 118. The image decoding apparatus 101 is also composed of frame memory 119, a switch 120, an intra prediction unit 121, an address controller 122, a nearby pixel availability determination unit 123, a motion prediction/compensation unit 124, and a switch 125.

The accumulation buffer 111 accumulates transmitted compressed images. The lossless decoder 112 decodes information that has been encoded by the lossless encoder 66 in FIG. 3 and supplied by the accumulation buffer 111 in a format corresponding to the encoding format of the lossless encoder 66.

In the example in FIG. 23, the lossless decoder 112 is composed of a stream input unit 131 and a decoding processor 132. The stream input unit 131 takes compressed images from the accumulation buffer 111 as input, and outputs data to the decoding processor 132 in that stream order (or in other words, the order illustrated by A in FIG. 2). The decoding processor 132 decodes data from the stream input unit 131 in the input stream order.

The dequantizer 113 dequantizes an image decoded by the lossless decoder 112 in a format corresponding to the quantization formation of the quantizer 65 in FIG. 3. The inverse orthogonal transform unit 114 applies an inverse orthogonal transform to the output of the dequantizer 113 in a format corresponding to the orthogonal transform format of the orthogonal transform unit 64 in FIG. 3.

The inverse orthogonally transformed output is added to a predicted image supplied from the switch 125 by the arithmetic unit 115 and decoded. After removing blocking artifacts from the decoded image, the deblocking filter 116 supplies it to the frame memory 119, where it is accumulated and also output to the frame sort buffer 117.

The frame sort buffer 117 sorts images, or in other words, takes an order of frames that have been sorted in encoding order by the frame sort buffer 62 in FIG. 3, and sorts them in their original display order. The D/A converter 118 D/A converts images supplied from the frame sort buffer 117 and outputs them for display to a display not illustrated.

The switch 120 reads out images to be inter processed and images to be referenced from the frame memory 119 and outputs them to the motion prediction/compensation unit 124, and in addition, reads out images to be used for intra prediction from the frame memory 119 and outputs them to the intra prediction unit 121.

The intra prediction unit 121 is supplied with information from the lossless decoder 112. The information indicates an intra prediction mode and is obtained by decoding header information. The intra prediction unit 121 supplies the address controller 122 with information on the next processing number, which indicates which block or blocks in a macroblock are to be processed next. In response, the intra prediction unit 121 acquires from the address controller 122 one or more block addresses and a control signal which controls or forbids pipeline processing or parallel processing. The intra prediction unit 121 also acquires information on the availability of pixels near the one or more target blocks to be processed from the nearby pixel availability determination unit 123.

The intra prediction unit 121 uses nearby pixels determined to be available by the nearby pixel availability determination unit 123 to conduct an intra prediction process on the one or more blocks corresponding to one or more block addresses from the address controller 122 in intra prediction modes from the lossless decoder 112. Furthermore, the intra prediction unit 121 conducts intra prediction on those blocks by pipeline processing or parallel processing at this point in the case where a control signal that controls pipeline processing or parallel processing has been received from the address controller 122.

Predicted images generated as a result of intra prediction by the intra prediction unit 121 are output to the switch 125.

The address controller 122, upon acquiring processing number information from the intra prediction unit 121, computes the one or more block addresses to be processed next in the same processing order as that of the address controller 75 in FIG. 3. Then, the address controller 122 supplies the computed one or more block addresses to the intra prediction unit 121 and the nearby pixel availability determination unit 123.

The address controller 122 also uses the computed one or more block addresses to determine whether or not pipeline processing or parallel processing of target blocks is possible. Depending on the determination result, the address controller 122 supplies the intra prediction unit 121 with a control signal that controls or forbids pipeline processing or parallel processing.

The nearby pixel availability determination unit 123 uses one or more block addresses from the address controller 122 to determine the availability of pixels near the one or more target blocks, and supplies information on the determined availability of nearby pixels to the intra prediction unit 121.

The motion prediction/compensation unit 124 is supplied with information obtained by decoding header information (prediction mode information, motion vector information, and reference frame information) from the lossless decoder 112. In the case where information indicating an inter prediction mode is supplied, the motion prediction/compensation unit 124 performs a motion prediction and compensation process on an image on the basis of motion vector information and reference frame information to generate a predicted image. The motion prediction/compensation unit 124 outputs a predicted image generated by an inter prediction mode to the switch 125.

The switch 125 selects a predicted image generated by the motion prediction/compensation unit 124 or the intra prediction unit 121 and supplies it to the arithmetic unit 115.

Herein, in the image encoding apparatus 51 in FIG. 3, an intra prediction process is conducted in all intra prediction modes for the purpose of prediction mode determination based on a cost function. In contrast, in the image decoding apparatus 101, an intra prediction process is conducted only on the basis of intra prediction mode information that has been encoded and transmitted.

### [Exemplary Configuration of Address Controller]

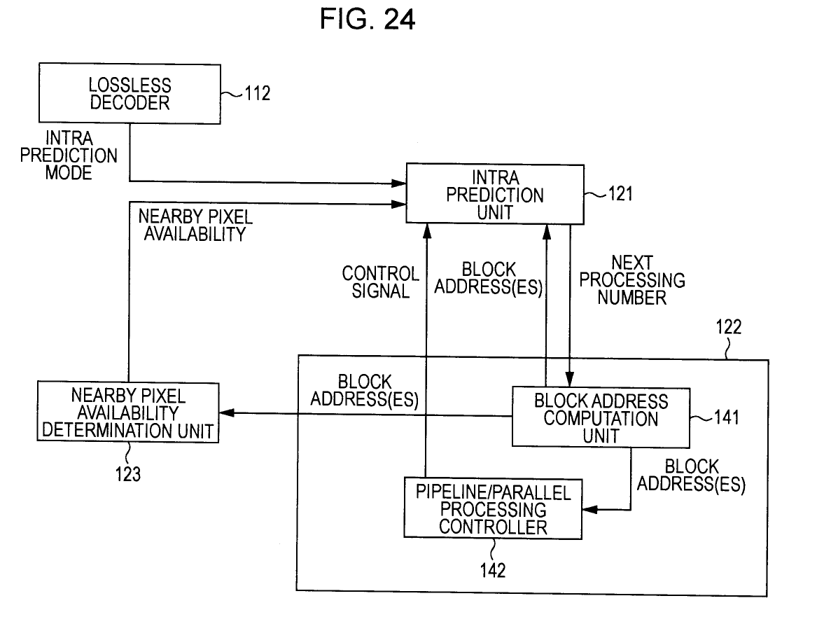

FIG. 24 is a block diagram illustrating an exemplary configuration of an address controller.

In the case of the example in FIG. 24, the address controller 122 is composed of a block address computation unit 141 and a pipeline/parallel processing controller 142.

The intra prediction unit 121 supplies the block address computation unit 141 with information on the next processing number for one or more blocks in a macroblock, similarly to the address controller 75 in FIG. 4.

The block address computation unit 141 conducts fundamentally similar processing to that of the block address computation unit 91 in FIG. 4. In other words, from a processing number from the intra prediction unit 121, the block address computation unit 141 computes and determines the block addresses of one or more target blocks to be processed next in a processing order that differs from the H.264/AVC processing order. The block address computation unit 141 supplies the determined one or more block addresses to the intra prediction unit 121, the pipeline/parallel processing controller 142, and the nearby pixel availability determination unit 123.

The pipeline/parallel processing controller 142 uses one or more block addresses from the block address computation unit 141 to determine whether or not pipeline processing or parallel processing of target blocks is possible. Depending on the determination result, the pipeline/parallel processing controller 142 supplies the intra prediction unit 121 with a control signal that controls or forbids pipeline processing or parallel processing.

The nearby pixel availability determination unit 123 conducts fundamentally similar processing to that of the nearby pixel availability determination unit 123 in FIG. 4. In other words, the nearby pixel availability determination unit 123 uses one or more block addresses from the address controller 122 to determine the availability of pixels near one or more target blocks, and supplies information on the determined availability of nearby pixels to the intra prediction unit 121.

The intra prediction unit 121 conducts an intra prediction process as follows on one or more target blocks corresponding to one or more block addresses from the block address computation unit 141. Namely, the intra prediction unit 121 uses nearby pixels determined to be available by the nearby pixel availability determination unit 123 to conduct an intra prediction process in an intra prediction mode from the lossless decoder 112. At this point, the intra prediction unit 121 conducts intra prediction on a plurality of blocks by pipeline processing or parallel processing, or conducts intra prediction on just a single block, on the basis of a control signal from the pipeline/parallel processing controller 142.

### [Description of Decoding Process in Image Decoding Apparatus]

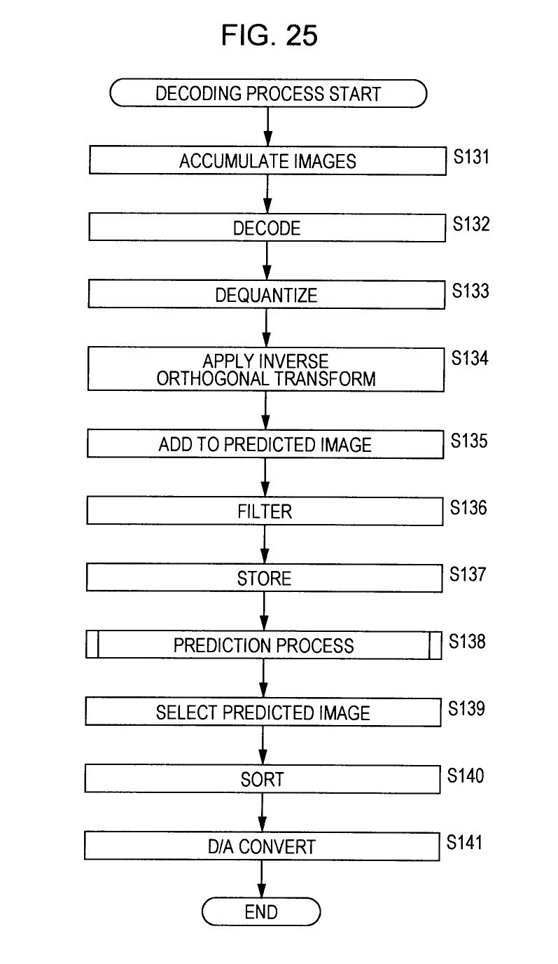

Next, a decoding process executed by the image decoding apparatus 101 will be described with reference to the flowchart in FIG. 25.

In a step S131, the accumulation buffer 111 accumulates transmitted images. The stream input unit 131 takes compressed images from the accumulation buffer 111 as input, and outputs data in that stream order to the decoding processor 132. In a step S132, the decoding processor 132 decodes compressed images supplied from the stream input unit 131. In other words, I-pictures, P-pictures, and B-pictures that have been encoded by the lossless encoder 66 in FIG. 3 are decoded.

At this point, motion vector information, reference frame information, prediction mode information (information indicating an intra prediction mode or an inter prediction mode), etc. are also decoded.

In other words, in the case where the prediction mode information is intra prediction mode information, the prediction mode information is supplied to the intra prediction unit 121. In the case where the prediction mode information is inter prediction mode information, motion vector information and reference frame information corresponding to the prediction mode information is supplied to the motion prediction/compensation unit 124.

In a step S133, the dequantizer 113 dequantizes transform coefficients decoded by the lossless decoder 112, with characteristics corresponding to the characteristics of the quantizer 65 in FIG. 3. In a step S134, the inverse orthogonal transform unit 114 applies an inverse orthogonal transform to transform coefficients dequantized by the dequantizer 113, with characteristics corresponding to the characteristics of the orthogonal transform unit 64 in FIG. 3. In so doing, difference information corresponding to the input into the orthogonal transform unit 64 in FIG. 3 (the output from the arithmetic unit 63) is decoded.

In a step S135, the arithmetic unit 115 adds the difference information to a predicted image that has been selected by the processing in a step S141 later discussed and input via the switch 125. In so doing, an original image is decoded. In a step S136, the deblocking filter 116 filters the image output by the arithmetic unit 115. In so doing, blocking artifacts are removed. In a step S137, the frame memory 119 stores the filtered image.

In a step S138, the intra prediction unit 121 and the motion prediction/compensation unit 124 respectively conduct an image prediction process corresponding to prediction mode information supplied from the lossless decoder 112.

At this point, the intra prediction unit 121 uses nearby pixels determined to be available by the nearby pixel availability determination unit 123 to conduct an intra prediction process on one or more target blocks corresponding to one or more block addresses determined by the address controller 122, in an intra prediction mode from the lossless decoder 112. The intra prediction unit 121 conducts intra prediction on those blocks by pipeline processing or parallel processing at this point in the case where a control signal that controls pipeline processing or parallel processing has been received from the address controller 122.

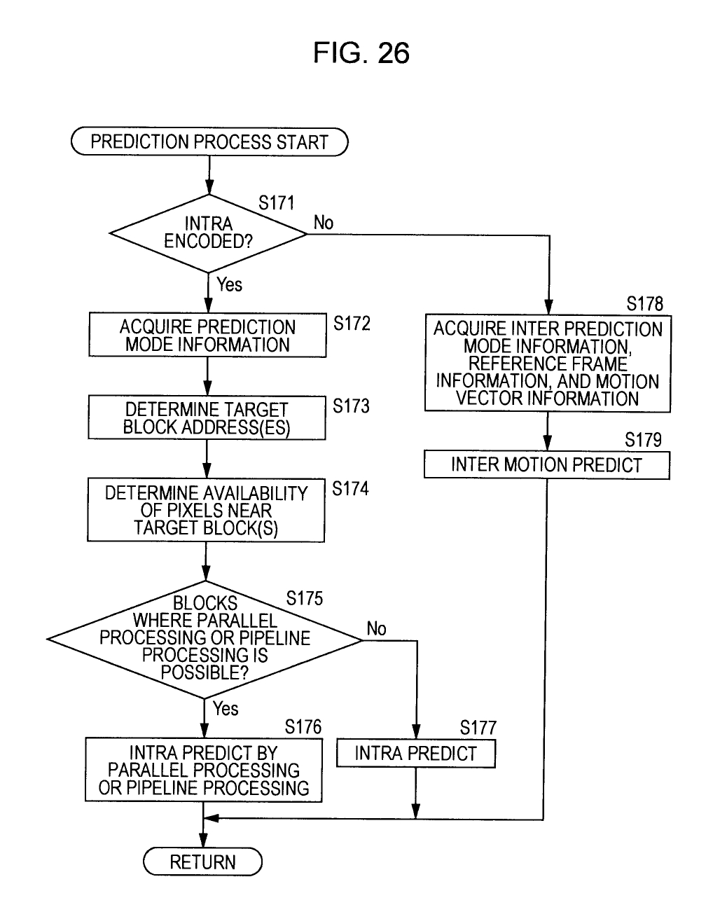

Details of the prediction process in step S138 will be discussed later with reference to FIG. 26, but as a result of this process, a predicted image generated by the intra prediction unit 121 or a predicted image generated by the motion prediction/compensation unit 124 is supplied to the switch 125.

In a step S139, the switch 125 selects a predicted image. In other words, a predicted image generated by the intra prediction unit 121 or a predicted image generated by the motion prediction/compensation unit 124 is supplied. Consequently, a supplied predicted image is selected and supplied to the arithmetic unit 115, and as discussed earlier, added to the output from the inverse orthogonal transform unit 114 in step S134.

Namely, in the case of intra prediction, the arithmetic unit 115 adds difference information for images of target blocks, which has been decoded, dequantized, and inverse orthogonally transformed in the stream order (the processing order in A of FIG. 2), to predicted images of target blocks, which have been generated by the intra prediction unit 121 in the processing order of A in FIG. 2.

Meanwhile, in the case of motion prediction, the arithmetic unit 115 adds difference information for images of target blocks, which has been decoded, dequantized, and inverse orthogonally transformed in the stream order (the H.264/AVC processing order), to predicted images of target blocks, which have been generated by the motion prediction/compensation unit 124 on the basis of the H.264/AVC processing order.

In a step S140, the frame sort buffer 117 conducts a sort. In other words, a frame order sorted for encoding by the frame sort buffer 62 in the image encoding apparatus 51 is re-sorted into the original display order.

In a step S141, the D/A converter 118 D/A converts an image from the frame sort buffer 117. This image is output to a display not illustrated, and the image is displayed.

### [Description of Prediction Process]

Next, the prediction process in step S138 of FIG. 25 will be described with reference to the flowchart in FIG. 26.

In a step S171, the intra prediction unit 121 determines whether or not a target block is intra coded. If intra prediction mode information is supplied to the intra prediction unit 121 from the lossless decoder 112, the intra prediction unit 121 determines that the target block is intra coded in step S171, and the process proceeds to a step S172.

In a step S172, the intra prediction unit 121 receives and acquires intra prediction mode information from the lossless decoder 112. If intra prediction mode information is received, the intra prediction unit 121 supplies the block address computation unit 141 with information on the next processing number, which indicates which block or blocks in a macroblock are to be processed next.

In a step S173 the block address computation unit 141, upon obtaining processing number information from the intra prediction unit 121, computes the one or more block addresses to be processed next in the same processing order as that of the block address computation unit 91 in FIG. 4. The block address computation unit 141 supplies the computed one or more block addresses to the intra prediction unit 121 and the nearby pixel availability determination unit 123.

In a step S174, the nearby pixel availability determination unit 123 uses one or more block addresses from the block address computation unit 141 to judge and determine the availability of pixels near the one or more target blocks. The nearby pixel availability determination unit 123 supplies information on the determined availability of nearby pixels to the intra prediction unit 121.

In a step S175, the pipeline/parallel processing controller 142 uses one or more block addresses from the block address computation unit 141 to determine whether or not the one or more target blocks are blocks which can be processed by pipeline processing or parallel processing.

In the case where it is determined in step S175 that the one or more target blocks are blocks which can be processed by pipeline processing or parallel processing, the pipeline/parallel processing controller 142 supplies the intra prediction unit 121 with a control signal that controls pipeline processing or parallel processing.

In response to this control signal, the intra prediction unit 121 intra predicts by parallel processing or pipeline processing in a step S176. In other words, the intra prediction unit 121 conducts an intra prediction process by parallel processing or pipeline processing on target blocks corresponding to two block addresses from the address controller 122 (block “2a” and block “2b” illustrated in A of FIG. 2, for example). At this point, the intra prediction unit 121 uses nearby pixels determined to be available by the nearby pixel availability determination unit 123 to conduct an intra prediction process in an intra prediction mode from the lossless decoder 112.

Also, in the case where it is determined in step S175 that the one or more target blocks are not blocks which can be processed by pipeline processing or parallel processing, the pipeline/parallel processing controller 142 supplies the intra prediction unit 121 with a control signal that forbids pipeline processing or parallel processing.

In response to this control signal, the intra prediction unit 121 intra predicts without parallel processing or pipeline processing. In other words, the intra prediction unit 121 conducts an intra prediction process for a target block corresponding to one block address from the address controller 122. At this point, the intra prediction unit 121 uses nearby pixels determined to be available by the nearby pixel availability determination unit 123 to conduct an intra prediction process in an intra prediction mode from the lossless decoder 112.

Meanwhile, in the case where it is determined in step S171 that a target block is not intra coded, the process proceeds to a step S178.

In the case where the processing target image is an image to be inter processed, inter prediction mode information, reference frame information, and motion vector information from the lossless decoder 112 is supplied to the motion prediction/compensation unit 124. In step S176, the motion prediction/compensation unit 124 acquires inter prediction mode information, reference frame information, and motion vector information, etc. from the lossless decoder 112.

Then, the motion prediction/compensation unit 124 inter motion predicts in a step S178. In other words, in the case where the processing target image is an image to be inter processed, necessary images are read out from the frame memory 119 and supplied to the motion prediction/compensation unit 124 via the switch 120. In step S179, the motion prediction/compensation unit 124 generates a predicted image by predicting motion in an inter prediction mode on the basis of motion vectors acquired in step S178. The predicted image thus generated is output to the switch 125.

As above, in an image encoding apparatus 51, encoding and stream output are conducted in the ascending order illustrated in A of FIG. 2, which differs from the H.264/AVC encoding order. Also, in an image decoding apparatus 101, stream input and decoding are conducted in a stream order from the image encoding apparatus 51 (or in other words, in the ascending order illustrated in A of FIG. 2 which differs from the H.264/AVC encoding order).

In so doing, pipeline processing or parallel processing becomes possible for two blocks having no interdependency regarding nearby pixels, as indicated by their having the same position in the processing order (block “2a” and block “2b” in A of FIG. 2, for example).

Also, since the encoding order and the output order is the same, unlike the proposal described in PTL 1, it is not necessary to provide a buffer between the encoding processor 81 and the stream output unit 82, and thus the circuit size can be reduced. This similarly applies to the case of the image decoding apparatus 101. Since the input order and the decoding order are the same, it is not necessary to provide a buffer between the stream input unit 131 and the decoding processor 132, and thus the circuit size can be reduced.

Furthermore, since the number of available nearby pixel values is increased and the number of candidate intra prediction modes is increased compared to the proposal described in PTL 1, pipeline processing and parallel processing can be realized with high coding efficiency.

Although the explanation above has described the case where the macroblock size is 16×16 pixels, it is also possible to apply the present invention to the extended macroblock sizes described in NPL 1 discussed earlier.

### [Description of Application to Extended Macroblock Sizes]

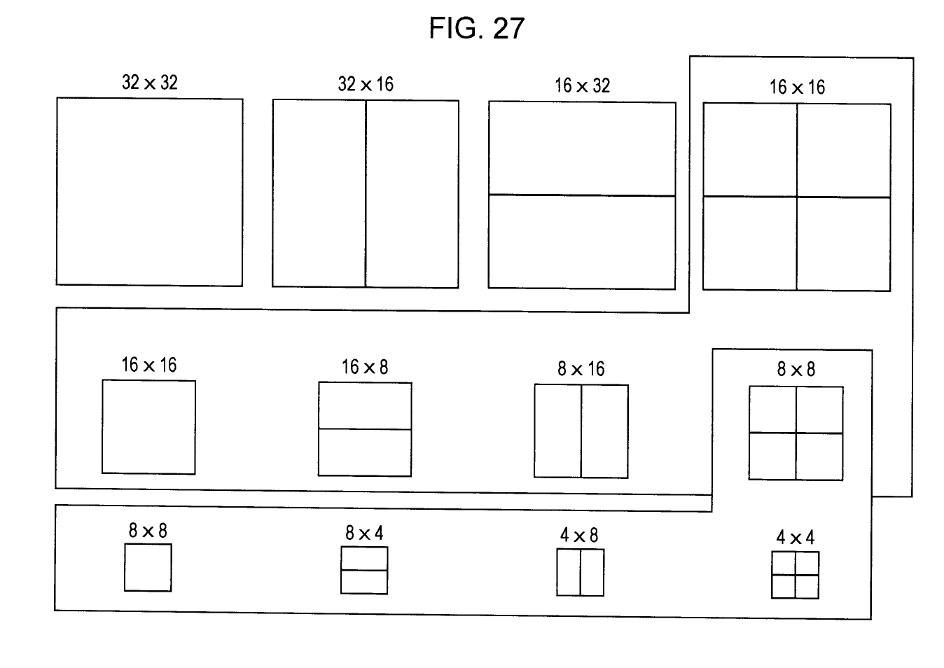

FIG. 27 is a diagram illustrating exemplary block sizes proposed in NPL 1. In NPL 1, the macroblock size is extended to 32×32 pixels.

On the top row in FIG. 27, macroblocks composed of 32×32 pixels and divided into 32×32 pixel, 32×16 pixel, 16×32 pixel, and 16×16 pixel blocks (partitions) are illustrated in order from the left. On the middle row in FIG. 27, blocks composed of 16×16 pixels and divided into 16×16 pixel, 16×8 pixel, 8×16 pixel, and 8×8 pixel blocks are illustrated in order from the left. Also, on the bottom row in FIG. 27, blocks composed of 8×8 pixels and divided into 8×8 pixel, 8×4 pixel, 4×8 pixel, and 4×4 pixel blocks are illustrated in order from the left.

In other words, it is possible to process a 32×32 pixel macroblock with the 32×32 pixel, 32×16 pixel, 16×32 pixel, and 16×16 pixel blocks illustrated on the top row of FIG. 27.

Also, it is possible to process the 16×16 pixel blocks illustrated on the right side of the top row with the 16×16 pixel, 16×8 pixel, 8×16 pixel, and 8×8 pixel blocks illustrated on the middle row, similarly to the H.264/AVC format.

Furthermore, it is possible to process the 8×8 pixel blocks illustrated on the right side of the middle row with the 8×8 pixel, 8×4 pixel, 4×8 pixel, and 4×4 pixel blocks illustrated on the bottom row, similarly to the H.264/AVC format.

With the proposal in NPL 1, by adopting a tiered structure in this way, larger blocks are defined as a superset while maintaining compatibility with the H.264/AVC format for blocks of 16×16 pixels or less.

A first method of applying the present invention to extended macroblock sizes proposed as above may involve applying the encoding order and the output order described in FIG. 2 to the 16×16 pixel blocks illustrated on the right side of the top row, for example.

For example, even if the macroblock size is 32×32 pixels, 64×64 pixels, or an even larger size, 16×16 pixel blocks may be used according to the tiered structure in NPL 1. The present invention can be applied to the encoding order and the output order inside such 16×16 pixel blocks.

Also, a second application method may involve applying the present invention to the encoding order and the output order for m/4×m/4 blocks in the case where the macroblock size is m×m pixels (where m≧16) and the units of orthogonal transformation are m/4×m/4.

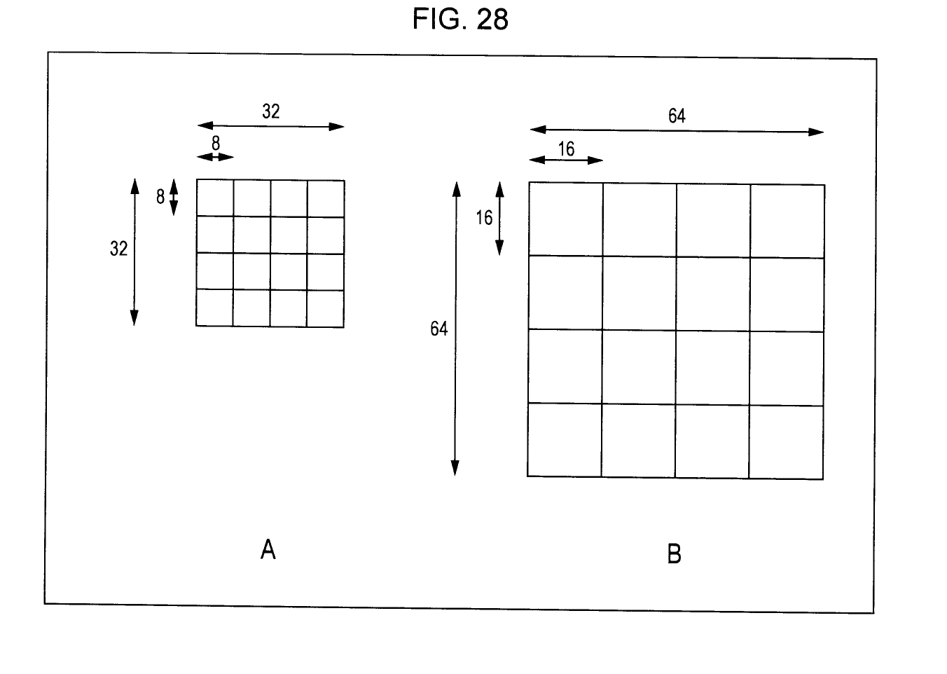

FIG. 28 is a diagram that specifically illustrates the second application method.

In FIG. 28, A illustrates the case where m=32, or in other words, the case where the macroblock size is 32×32 pixels and the units of orthogonal transformation are 8×8 blocks. In the case where the macroblock size is 32×32 pixels and the units of orthogonal transformation are 8×8 blocks as illustrated in A of FIG. 28, the present invention can be applied to the encoding order and the output order for 8×8 blocks inside such macroblocks.

Also, in FIG. 28, B illustrates the case where m=64, or in other words, the case where the macroblock size is 64×64 pixels and the units of orthogonal transformation are 16×16 blocks. In the case where the macroblock size is 64×64 pixels and the units of orthogonal transformation are 16×16 blocks as illustrated in B of FIG. 28, the present invention can be applied to the encoding order and the output order for 16×16 blocks inside such macroblocks.

Meanwhile, with the second application method, the case where m=16 is equivalent to example discussed earlier wherein the macroblock size is 16×16 pixels and the units of orthogonal transformation are 4×4 pixel blocks.

Although it is configured such that the H.264/AVC format is used as the coding format in the foregoing, the present invention is not limited thereto, and may be applied to other encoding formats and decoding formats which conduct prediction using adjacent pixels.

Furthermore, the present invention may be applied to an image encoding apparatus and an image decoding apparatus used when receiving image information which has been compressed by an orthogonal transform such as the discrete cosine transform and motion compensation as in MPEG or H.26x (a bit stream) via a network medium such as satellite broadcasting, cable television, the Internet, or a mobile phone, for example. Also, the present invention may be applied to an image encoding apparatus and an image decoding apparatus used when processing information on storage media such as optical or magnetic disks and flash memory. Moreover, the present invention may also be applied to a motion prediction and compensation apparatus included in such image encoding apparatus and image decoding apparatus, etc.

The foregoing series of processes may be executed in hardware, and may also be executed in software. In the case of executing the series of processes in software, a program constituting such software is installed onto a computer. Herein, the term computer includes computers built into special-purpose hardware, and general-purpose personal computers able to execute various functions by installing various programs thereon.

### [Exemplary Configuration of Personal Computer]

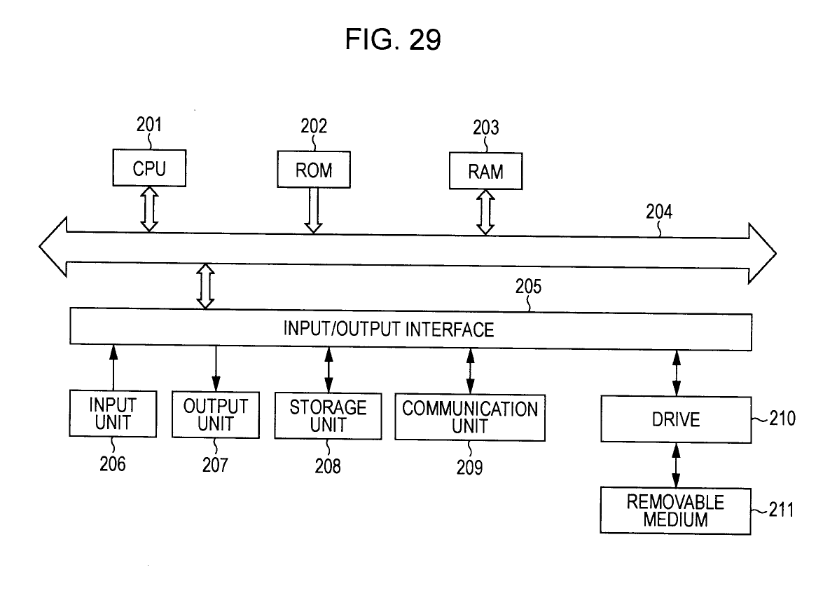

FIG. 29 is a block diagram illustrating an exemplary hardware configuration of a computer that executes the foregoing series of processes according to a program.

In a computer, a central processing unit (CPU) 201, read-only memory (ROM) 202, and random access memory (RAM) 203 are connected to each other by a bus 204.

An input/output interface 205 is additionally connected to the bus 204. An input unit 206, an output unit 207, a storage unit 208, a communication unit 209, and a drive 210 are connected to the input/output interface 205.

The input unit 206 comprises a keyboard, mouse, microphone, etc. The output unit 207 comprises a display, speakers, etc. The storage unit 208 comprises a hard disk, non-volatile memory, etc. The communication unit 209 comprises a network interface, etc. The drive 210 drives a removable medium 211 such as a magnetic disk, an optical disc, a magneto-optical disc, or semiconductor memory.

In a computer configured as above, the series of processes discussed earlier is conducted as a result of the CPU 201 loading a program stored in the storage unit 208 into the RAM 203 via the input/output interface 205 and the bus 204, and executing the program, for example.

The program executed by the computer (CPU 201) may be provided by being recorded onto a removable medium 211 given as packaged media, etc. Also, the program may be provided via a wired or wireless transmission medium such as a local area network, the Internet, or digital satellite broadcasting.

On the computer, the program may be installed to the storage unit 208 via the input/output interface 205 by loading the removable medium 211 into the drive 210. Also, the program may be received by the communication unit 209 via a wired or wireless transmission medium and installed to the storage unit 208. Otherwise, the program may be installed in advance to the ROM 202 or the storage unit 208.

Furthermore, the program executed by the computer may be a program whereby processes are conducted in a time series following the order described in this specification, and may also be a program whereby processes are conducted in parallel or at required timings, such as when called.

Embodiments of the present invention are not limited to the embodiments discussed above, and various modifications are possible within a scope that does not depart from the principal matter of the present invention.

For example, the image encoding apparatus 51 and the image decoding apparatus 101 discussed earlier may be applied to arbitrary electronic devices. Hereinafter, examples of such will be described.

### [Exemplary Configuration of Television Receiver]

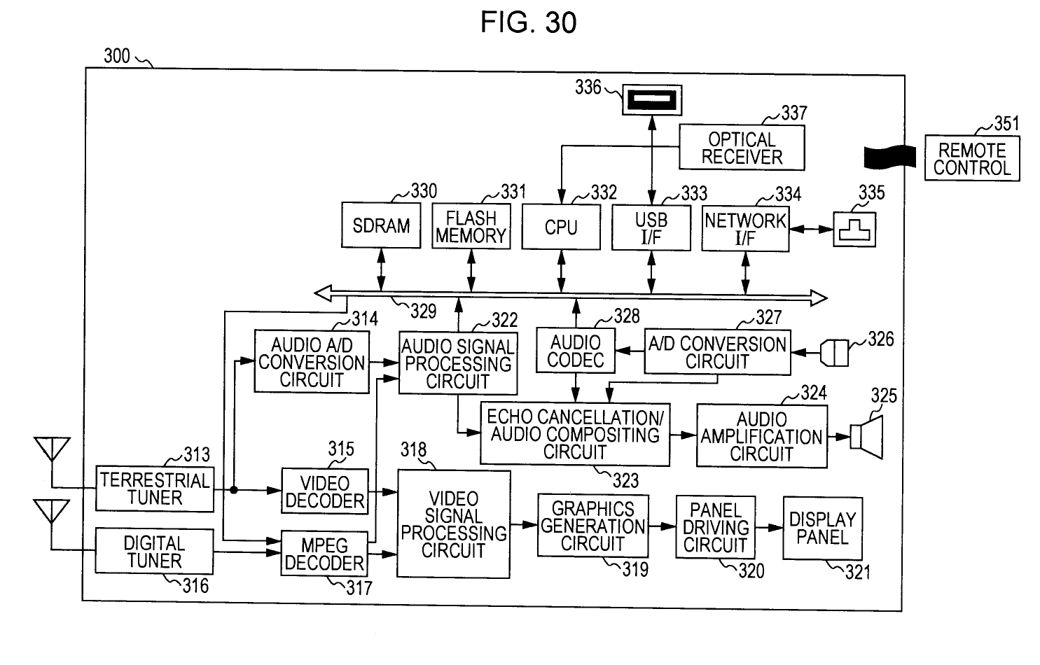

FIG. 30 is a block diagram illustrating an exemplary primary configuration of a television receiver which uses an image decoding apparatus to which the present invention has been applied.

The television receiver 300 illustrated in FIG. 30 includes a terrestrial tuner 313, a video decoder 315, a video signal processing circuit 318, a graphics generation circuit 319, a panel driving circuit 320, and a display panel 321.

The terrestrial tuner 313 receives the broadcast signal of an analog terrestrial broadcast via an antenna, demodulates it to acquire a video signal, and supplies the result to the video decoder 315. The video decoder 315 decodes a video signal supplied from the terrestrial tuner 313 and supplies the obtained digital component signals to the video signal processing circuit 318.

The video signal processing circuit 318 performs given processing such as noise removal on video data supplied from the video decoder 315 and supplies the obtained video data to the graphics generation circuit 319.

The graphics generation circuit 319 generates video data of a program to be displayed by the display panel 321 and image data according to processing based on an application supplied via a network, and supplies the generated video data and image data to the panel driving circuit 320. The graphics generation circuit 319 also conducts other processing as appropriate, such as generating video data (graphics) displaying a screen used by the user for item selection, etc., and supplying the panel driving circuit 320 with video data obtained by superimposing or otherwise combining such graphics with the video data of a program.

The panel driving circuit 320 drives the display panel 321 on the basis of data supplied from the graphics generation circuit 319, and causes the display panel 321 to display program video and the various screens discussed above.

The display panel 321 consists of a liquid crystal display (LCD), etc. and displays program video, etc. under control by the panel driving circuit 320.

The television receiver 300 also includes an audio analog/digital (A/D) conversion circuit 314, an audio signal processing circuit 322, an echo cancellation/speech synthesis circuit 323, an audio amplification circuit 324, and speakers 325.

The terrestrial tuner 313 acquires not only a video signal but also an audio signal by demodulating a received broadcast signal. The terrestrial tuner 313 supplies the obtained audio signal to the audio A/D conversion circuit 314.

The audio A/D conversion circuit 314 performs A/D conversion processing on an audio signal supplied from the terrestrial tuner 313, and supplies the obtained digital audio signal to the audio signal processing circuit 322.

The audio signal processing circuit 322 performs given processing such as noise removal on audio data supplied from the audio A/D conversion circuit 314, and supplies the obtained audio data to the echo cancellation/speech synthesis circuit 323.

The echo cancellation/speech synthesis circuit 323 supplies audio data supplied from the audio signal processing circuit 322 to the audio amplification circuit 324.

The audio amplification circuit 324 performs D/A conversion processing and amplification processing on audio data supplied from the echo cancellation/speech synthesis circuit 323, and causes audio to be output from the speakers 325 after adjusting it to a given volume.

Additionally, the television receiver 300 includes a digital tuner 316 and an MPEG decoder 317.

The digital tuner 316 receives the broadcast signal of digital broadcasting (digital terrestrial broadcasting, Broadcasting Satellite (BS)/Communications Satellite (CS) digital broadcasting) via an antenna, demodulates it to acquire an MPEG-TS (Moving Picture Experts Group-Transport Stream), and supplies the result to the MPEG decoder 317.

The MPEG decoder 317 descrambles an MPEG-TS supplied from the digital tuner 316 and extracts streams which include data for a program to be played back (viewed). The MPEG decoder 317 decodes audio packets constituting an extracted stream and supplies the obtained audio data to the audio signal processing circuit 322, and additionally decodes video packets constituting a stream and supplies the obtained video data to the video signal processing circuit 318. Also, the MPEG decoder 317 supplies electronic program guide (EPG) data extracted from the MPEG-TS to a CPU 332 via a pathway not illustrated.

The television receiver 300 uses the image decoding apparatus 101 discussed earlier as the MPEG decoder 317 which decodes video packets in this way. Consequently, a stream that has been encoded and output in the ascending order illustrated in A of FIG. 2, which differs from the H.264/AVC encoding order, is input into and decoded by the MPEG decoder 317 in that stream order, similarly to the case of the image decoding apparatus 101. In so doing, pipeline processing and parallel processing can be realized with high coding efficiency.

Video data supplied from the MPEG decoder 317 is subjected to given processing in the video signal processing circuit 318, similarly to the case of video data supplied from the video decoder 315. Then, video data which has been subjected to given processing is suitably superimposed with generated video data, etc. in the graphics generation circuit 319, and the resulting image is supplied to the display panel 321 via the panel driving circuit 320 and displayed.

Audio data supplied from the MPEG decoder 317 is subjected to given processing in the audio signal processing circuit 322, similarly to the case of audio data supplied from the audio A/D conversion circuit 314. Then, audio data which has been subjected to given processing is supplied to the audio amplification circuit 324 via the echo cancellation/audio compositing circuit 323 and subjected to D/A conversion processing and amplification processing. As a result, audio which has been adjusted to a given volume is output from the speakers 325.

The television receiver 300 also includes a microphone 326 and an A/D conversion circuit 327.

The A/D conversion circuit 327 receives a user's audio signal picked up by a microphone 326 provided in the television receiver 300 as a telephony device. The A/D conversion circuit 327 performs A/D conversion processing on the received audio signal and supplies the obtained digital audio signal to the echo cancellation/audio compositing circuit 323.

In the case where audio data of the user of the television receiver 300 (user A) is supplied from the A/D conversion circuit 327, the echo cancellation/audio compositing circuit 323 applies echo cancelling to user A's audio data. Then, after echo cancelling, the echo cancellation/audio compositing circuit 323 composites it with other audio data, etc., and causes the audio data obtained as a result to be output by the speakers 325 via the audio amplification circuit 324.

Furthermore, the television receiver 300 also includes an audio codec 328, an internal bus 329, synchronous dynamic random-access memory (SDRAM) 330, flash memory 331, a CPU 332, a Universal Serial Bus (USB) I/F 333, and a network I/F 334.

The A/D conversion circuit 327 receives a user's audio signal picked up by the microphone 326 provided in the television receiver 300 as a telephony device. The A/D conversion circuit 327 performs A/D conversion processing on the received audio signal and supplies the obtained digital audio data to the audio codec 328.

The audio codec 328 converts audio data supplied from the A/D conversion circuit 327 into data of a given format for transmission via a network, and supplies the result to the network I/F 334 via the internal bus 329.

The network I/F 334 is connected to a network via a cable inserted into a network port 335. The network I/F 334 may transmit audio data supplied from the audio codec 328 to another apparatus connected to the network, for example. The network I/F 334 may also receive, via the network port 335, audio data transmitted from another apparatus connected via the network and supply it to the audio codec 328 via the internal bus 329, for example.

The audio codec 328 converts audio data supplied from the network I/F 334 into data of a given format and supplies it to the echo cancellation/audio compositing circuit 323.

The echo cancellation/audio compositing circuit 323 applies echo cancelling to audio data supplied from the audio codec 328, composites it with other audio data, etc., and causes the audio data obtained as a result to be output by the speakers 325 via the audio amplification circuit 324.

The SDRAM 330 stores various data required for processing by the CPU 332.

The flash memory 331 stores programs executed by the CPU 332. Programs stored in the flash memory 331 are read out by the CPU 332 at given timings, such as when booting up the television receiver 300. The flash memory 331 also stores information such as EPG data acquired via digital broadcasting and data acquired from a given server via a network.

For example, the flash memory 331 may store an MPEG-TS including content data acquired from a given server via a network under control by the CPU 332. The flash memory 331 may supply the MPEG-TS to the MPEG decoder 317 via the internal bus 329 under control by the CPU 332, for example.

The MPEG decoder 317 processes the MPEG-TS, similarly to the case of an MPEG-TS supplied from the digital tuner 316. In this way, the television receiver 300 is able to receive content data consisting of video and audio, etc. via a network, decode it using the MPEG decoder 317, and then cause the video to be displayed and the audio to be output.

The television receiver 300 also includes an optical receiver 337 which receives infrared signals transmitted from a remote control 351.

The optical receiver 337 receives infrared light from the remote control 351, demodulates it, and outputs a control code expressing the content of a user operation obtained as a result to the CPU 332.

The CPU 332 executes a program stored in the flash memory 331 and controls the overall operation of the television receiver 300 according to information such as control codes supplied from the optical receiver 337. The CPU 332 and the respective components of the television receiver 300 are connected via pathways not illustrated.

The USB I/F 333 transmits and receives data to and from devices external to the television receiver 300 which are connected via a USB cable inserted into a USB port 336. The network I/F 334 connects to a network via a cable inserted into a network port 335 and likewise transmits and receives data other than audio data to and from various apparatus connected to the network.

By using the image decoding apparatus 101 as an MPEG decoder 317, the television receiver 300 is able to realize faster processing while also generating highly accurate predicted images. As a result, the television receiver 300 is able to obtain and display decoded images faster and in higher definition from broadcast signals received via an antenna and content data acquired via a network.

### [Exemplary Configuration of Mobile Phone]

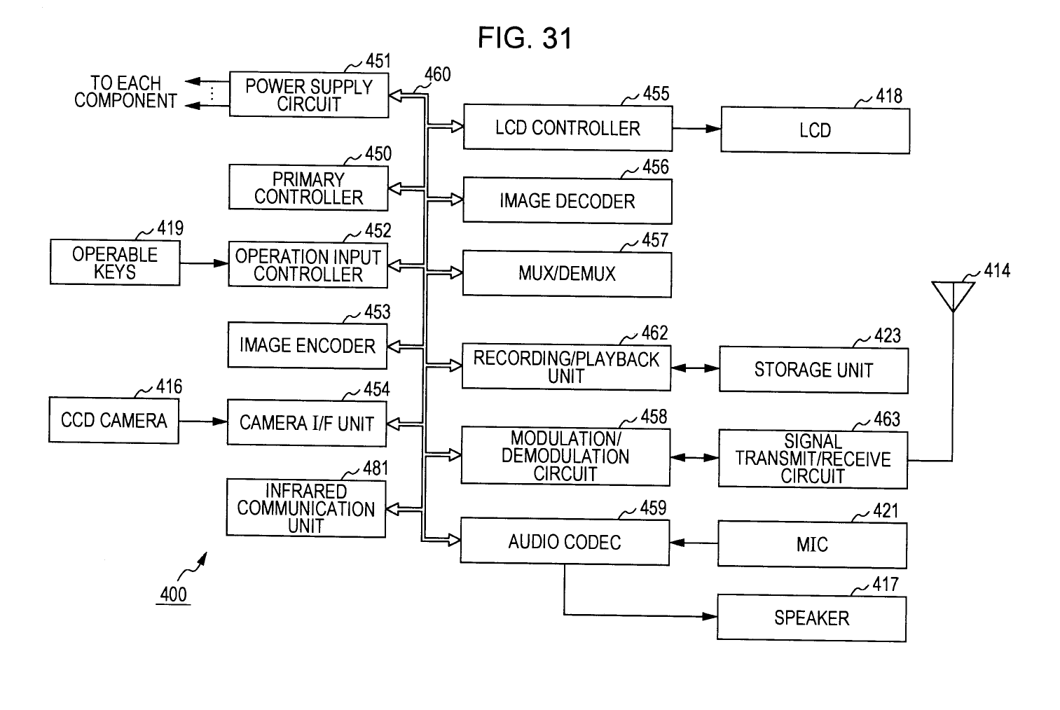

FIG. 31 is a block diagram illustrating an exemplary primary configuration of a mobile phone which uses an image encoding apparatus and an image decoding apparatus to which the present invention has been applied.

The mobile phone 400 illustrated in FIG. 31 includes a primary controller 450 configured to execute supervisory control of the respective components, a power supply circuit 451, an operation input controller 452, an image encoder 453, a camera I/F 454, an LCD controller 455, an image decoder 456, a mux/demux 457, a recording/playback unit 462, a modulation/demodulation circuit 458, and an audio codec 459. These are connected to each other via a bus 460.

The mobile phone 400 also includes operable keys 419, a charge-coupled device (CCD) camera 416, a liquid crystal display 418, a storage unit 423, a signal transmit/receive circuit 463, an antenna 414, a microphone (mic) 421, and a speaker 417.

When an End Call and Power key is put into an on state by a user operation, the power supply circuit 451 boots the mobile phone 400 into an operable state by supplying power to its respective components from a battery pack.

On the basis of control by a primary controller 450 consisting of a CPU, ROM, and RAM, etc., the mobile phone 400 conducts various operations such as transmitting/receiving audio signals, transmitting/receiving email and image data, shooting images, and storing data while operating in various modes such as an audio telephony mode and a data communication mode.

For example, in the audio telephony mode, the mobile phone 400 converts an audio signal picked up by the microphone (mic) 421 into digital audio data by means of the audio codec 459, applies spread-spectrum processing with the modulation/demodulation circuit 458, and applies digital/analog conversion processing and frequency conversion processing with the signal transmit/receive circuit 463. The mobile phone 400 transmits the transmit signal obtained by such conversion processing to a base station (not illustrated) via the antenna 414. The transmit signal (audio signal) transmitted to the base station is supplied to the mobile phone of the telephony peer via the public switched telephone network.

As another example, in the audio telephony mode, the mobile phone 400 takes a received signal received by the antenna 414, amplifies it, and additionally applies frequency conversion processing and analog/digital conversion processing with the signal transmit/receive circuit 463, applies spread-spectrum despreading processing with the modulation/demodulation circuit 458, and converts it into an analog audio signal by means of the audio codec 459. The mobile phone 400 outputs the analog audio signal obtained as a result of such conversion from the speaker 417.

As a further example, in the case of transmitting email in the data communication mode, the mobile phone 400 receives with the operation input controller 452 text data of an email input by operations on the operable keys 419. The mobile phone 400 processes the text data in the primary controller 450 and causes it to be displayed as an image on the liquid crystal display 418 via the LCD controller 455.

The mobile phone 400 also generates email data in the primary controller 450 on the basis of information such as text data and user instructions received by the operation input controller 452. The mobile phone 400 applies spread-spectrum processing with the modulation/demodulation circuit 458, and applies digital/analog conversion processing and frequency conversion processing with the signal transmit/receive circuit 463 to the email data. The mobile phone 400 transmits the transmit signal obtained as a result of such conversion processing to a base station (not illustrated) via the antenna 414. The transmit signal (email) transmitted to the base station is supplied to a given recipient via a network and mail server, etc.

As another example, in the case of receiving email in the data communication mode, the mobile phone 400 receives a signal transmitted from a base station via the antenna 414, amplifies it, and additionally applies frequency conversion processing and analog/digital conversion processing with the signal transmit/receive circuit 463. The mobile phone 400 reconstructs the email data by applying spread-spectrum despreading to the received signal with the modulation/demodulation circuit 458. The mobile phone 400 displays the reconstructed email data on the liquid crystal display 418 via the LCD controller 455.

Furthermore, the mobile phone 400 is also able to record received email data (i.e., cause it to be stored) to the storage unit 423 via the recording/playback unit 462.

The storage unit 423 is an arbitrary rewritable storage medium. The storage unit 423 may for example be semiconductor memory such as RAM or internal flash memory, it may be a hard disk, or it may be a removable medium such as a magnetic disk, a magneto-optical disc, an optical disc, USB memory, or a memory card. Obviously, it may also be something other than the above.

As a further example, in the case of transmitting image data in the data communication mode, the mobile phone 400 generates image data by shooting with the CCD camera 416. The CCD camera 416 includes optical devices such as a lens and an aperture, and a CCD as a photoelectric transducer. The CCD camera 416 shoots a subject, converts the strength of the received light into an electrical signal, and generates image data for an image of the subject. The image data is converted into encoded image data as a result of compression coding conducted in the image encoder 453 via the camera I/F 454 with a given encoding format such as MPEG-2 or MPEG-4, for example.

The mobile phone 400 uses the image encoding apparatus 51 discussed earlier as the image encoder 453 which conducts such processing. Consequently, the image encoder 453 conducts encoding and stream output in the ascending order illustrated in A of FIG. 2, which differs from the H.264/AVC encoding order, similarly to the case of the image encoding apparatus 51. In so doing, pipeline processing and parallel processing can be realized with high coding efficiency. Additionally, the circuit size of the image encoder 453 can be reduced.

Meanwhile, at the same time, the mobile phone 400 takes audio picked up by the microphone (mic) 421 while shooting with the CCD camera 416, applies analog/digital conversion thereto and additionally encodes it with the audio codec 459.

The mobile phone 400 multiplexes encoded image data supplied from the image encoder 453 and digital audio data supplied from the audio codec 459 in a given format with the mux/demux 457. The mobile phone 400 applies spread-spectrum processing to the multiplexed data obtained as a result with the modulation/demodulation circuit 458, and applies digital/analog processing and frequency conversion processing with the signal transmit/receive circuit 463. The mobile phone 400 transmits the transmit signal obtained as a result of such conversion processing to a base station (not illustrated) via the antenna 414. The transmit signal (image data) transmitted to the base station is supplied to a communication peer via a network, etc.

Meanwhile, in the case of not transmitting image data, the mobile phone 400 may also take image data generated by the CCD camera 416 and cause it to be displayed on the liquid crystal display 418 via the LCD controller 455, bypassing the image encoder 453.

As another example, in the case of receiving motion image file data linked from a simple homepage, etc. in the data communication mode, the mobile phone 400 receives a signal transmitted from the base station via the antenna 414, amplifies it, and additionally applies frequency conversion processing and analog/digital processing with the signal transmit/receive circuit 463. The mobile phone 400 applies spread-spectrum despreading to the received signal with the modulation/demodulation circuit 458 to reconstruct the original multiplexed data. The mobile phone 400 demultiplexes the multiplexed data and separates the encoded image data and audio data in the mux/demux 457.

The mobile phone 400 generates playback motion image data by decoding encoded image data with the image decoder 456 in a decoding format corresponding to a given encoding format such as MPEG-2 or MPEG-4, and causes it to be displayed on the liquid crystal display 418 via the LCD controller 455. In so doing, motion image data included in a motion image file linked from a simple homepage is displayed on the liquid crystal display 418, for example.

The mobile phone 400 uses the image decoding apparatus 101 discussed earlier as the image decoder 456 which conducts such processing. Consequently, a stream that has been encoded and output in the ascending order illustrated in A of FIG. 2, which differs from the H.264/AVC encoding order, is input into and decoded by the image decoder 456 in that stream order, similarly to the case of the image decoding apparatus 101. In so doing, pipeline processing and parallel processing can be realized with high coding efficiency. Additionally, the circuit size of the image decoder 456 can be reduced.

At this point, the mobile phone 400 simultaneously converts digital audio data into an analog audio signal with the audio codec 459 and causes it to be output by the speaker 417. In so doing, audio data included in a motion image file linked from a simple homepage is played back, for example.

Furthermore, similarly to the case of email, the mobile phone 400 is also able to record received data linked from a simple homepage, etc. (i.e., cause it to be stored) to the storage unit 423 via the recording/playback unit 462.

Also, the mobile phone 400 is able to analyze a two-dimensional code shot and obtained with the CCD camera 416 and acquire information recorded in that two-dimensional code with the primary controller 450.

Furthermore, the mobile phone 400 is able to communicate with an external device by infrared light with the infrared communication unit 481.

By using the image encoding apparatus 51 as an image encoder 453, the mobile phone 400 is able to realize faster processing, while also improving the coding efficiency of encoded data generated by encoding image data generated with the CCD camera 416, for example. As a result, the mobile phone 400 is able to provide encoded data (image) with high coding efficiency to other apparatus.

Also, by using the image decoding apparatus 101 as an image decoder 456, the mobile phone 400 is able to realize faster processing, while also generating highly accurate predicted images. As a result, the mobile phone 400 is able to obtain and display decoded images in higher definition from a motion image file linked from a simple homepage, for example.

Although the foregoing describes the mobile phone 400 as using a CCD camera 416, it may also be configured such that an image sensor using a complementary metal-oxide-semiconductor (CMOS image sensor) is used instead of the CCD camera 416. Even in this case, the mobile phone 400 is still able to shoot a subject and generate image data for an image of the subject, similarly to the case of using the CCD camera 416.

Also, although the foregoing has been described as a mobile phone 400, the image encoding apparatus 51 and the image decoding apparatus 101 can be applied similarly to the case of the mobile phone 400 to any apparatus having imaging functions and communication functions similar to those of the mobile phone 400, such as a personal digital assistant (PDA), a smartphone, an ultra mobile personal computer (UMPC), a netbook, or a notebook computer, for example.

### [Exemplary Configuration of Hard Disk Recorder]

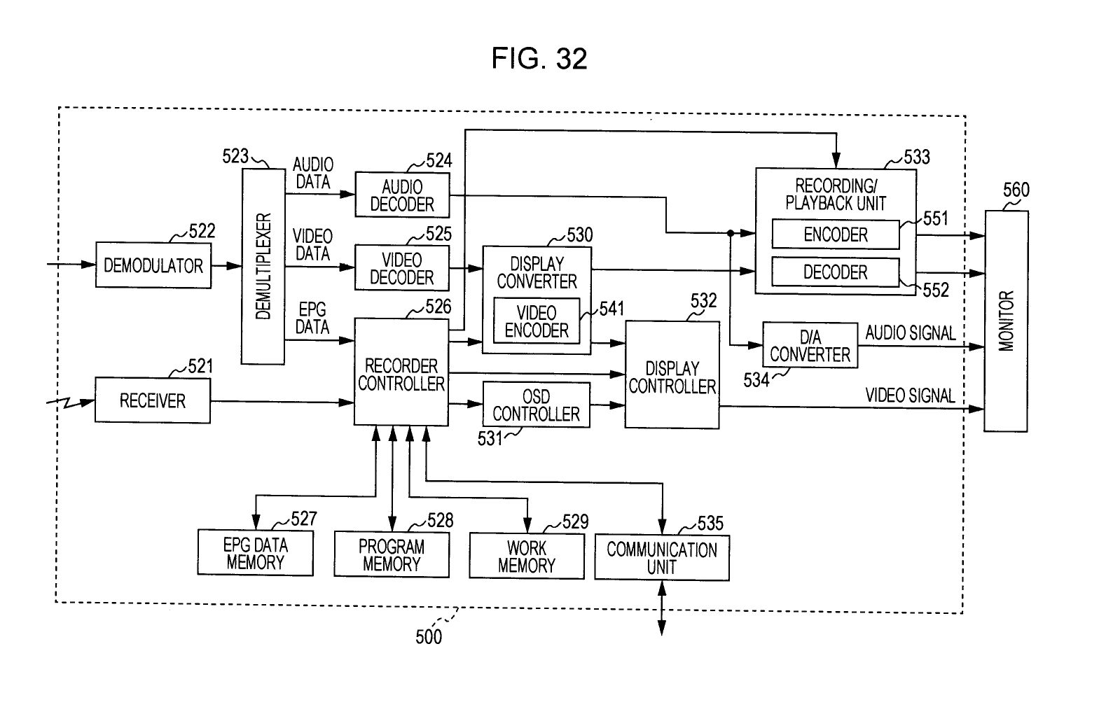

FIG. 32 is a block diagram illustrating an exemplary primary configuration of a hard disk recorder which uses an image encoding apparatus and an image decoding apparatus to which the present invention has been applied.

The hard disk recorder (HDD recorder) 500 illustrated in FIG. 32 is an apparatus that takes audio data and video data of a broadcast program included in a broadcast signal (television signal) transmitted by satellite or terrestrial antenna, etc. and received by a tuner, saves the data to an internal hard disk, and presents such saved data to a user at timings in accordance with user instructions.

The hard disk recorder 500 is able to extract audio data and video data from a broadcast signal, suitably decode it, and cause it to be stored in an internal hard disk, for example. The hard disk recorder 500 is also able to acquire audio data and video data from other apparatus via a network, suitably decode it, and cause it to be stored in an internal hard disk, for example.

Furthermore, the hard disk recorder 500 decodes audio data and video data recorded to an internal hard disk, supplies it to a monitor 560, and causes images thereof to be displayed on the screen of the monitor 560, for example. The hard disk recorder 500 is also able to cause audio thereof to be output from speakers in the monitor 560.

The hard disk recorder 500 decodes audio data and video data extracted from a broadcast signal acquired via a tuner or audio data and video data acquired from another apparatus via a network, supplies it to the primary controller 450, and causes images thereof to be displayed on the screen of the monitor 560, for example. The hard disk recorder 500 is also able to cause audio thereof to be output from speakers in the monitor 560, for example.

Obviously, other operations are also possible.

As illustrated in FIG. 32, the hard disk recorder 500 includes a receiver 521, a demodulator 522, a demultiplexer 523, an audio decoder 524, a video decoder 525, and a recorder controller 526. The hard disk recorder 500 additionally includes EPG data memory 527, program memory 528, work memory 529, a display converter 530, an on-screen display (OSD) controller 531, a display controller 532, a recording/playback unit 533, a D/A converter 534, and a communication unit 535.

Also, the display converter 530 includes a video encoder 541. The recording/playback unit 533 includes an encoder 551 and a decoder 552.

The receiver 521 receives an infrared signal from a remote control (not illustrated), converts it into an electrical signal, and outputs it to the recorder controller 526. The recorder controller 526 comprises a microprocessor, etc., and executes various processing following a program stored in the program memory 528, for example. During such times, the recorder controller 526 uses the work memory 529 as necessary.

The communication unit 535 is connected to a network and communicates with other apparatus via the network. For example, the communication unit 535 communicates with a tuner (not illustrated) under control by the recorder controller 526 and primarily outputs channel selection control signals to the tuner.

The demodulator 522 demodulates a signal supplied by the tuner and outputs it to the demultiplexer 523. The demultiplexer 523 separates data supplied by the demodulator 522 into audio data, video data, and EPG data, and respectively outputs them to the audio decoder 524, the video decoder 525, and the recorder controller 526.

The audio decoder 524 decodes input audio data in MPEG format, for example, and outputs it to the recording/playback unit 533. The video decoder 525 decodes input video data in the MPEG format, for example, and outputs it to the display converter 530. The recorder controller 526 supplies input EPG data to the EPG data memory 527 for storage.

The display converter 530 takes video data supplied by the video decoder 525 or the recorder controller 526, encodes it into video data in NTSC (National Television Standards Committee) format, for example, with the video encoder 541, and outputs it to the recording/playback unit 533. Also, the display converter 530 converts the screen size of video data supplied by the video decoder 525 or the recorder controller 526 into a size corresponding to the size of the monitor 560. The display converter 530 takes screen size-converted video data and additionally converts it into NTSC format video data with the video encoder 541, converts it into an analog signal, and outputs it to the display controller 532.

Under control by the recorder controller 526, the display controller 532 takes an OSD signal output by the on-screen display (OSD) controller 531, superimposes it onto a video signal input by the display converter 530, and outputs the result to the display of the monitor 560 for display.

The monitor 560 is also supplied with audio data which has been output by the audio decoder 524 and converted into an analog signal by the D/A converter 534. The monitor 560 outputs the audio signal from internal speakers.

The recording/playback unit 533 includes a hard disk as a storage medium which records video data and audio data, etc.

The recording/playback unit 533 encodes audio data supplied by the audio decoder 524 in MPEG format with the encoder 551, for example. The recording/playback unit 533 also encodes video data supplied by the video encoder 541 of the display converter 530 in MPEG format with the encoder 551. The recording/playback unit 533 combines the encoded data of the audio data and the encoded data of the video data with a multiplexer. The recording/playback unit 533 channel codes and amplifies the combined data, and writes the data to the hard disk via a recording head.

The recording/playback unit 533 plays back data recorded to the hard disk via a playback head, amplifies it, and separates it into audio data and video data with a demultiplexer. The recording/playback unit 533 decodes audio data and video data in MPEG format with the decoder 552. The recording/playback unit 533 D/A converts the decoded audio data and outputs it to the speakers of the monitor 560. The recording/playback unit 533 also D/A converts the decoded video data and outputs it to the display of the monitor 560.

The recorder controller 526 reads out the most recent EPG data from the EPG data memory 527 and supplies it to the OSD controller 531 on the basis of user instructions expressed by an infrared signal from the remote control received via the receiver 521. The OSD controller 531 produces image data corresponding to the input EPG data and outputs it to the display controller 532. The display controller 532 outputs video data input by the OSD controller 531 to the display of the monitor 560 for display. In so doing, an EPG (electronic program guide) is displayed on the display of the monitor 560.

The hard disk recorder 500 is also able to acquire various data such as video data, audio data, and EPG data supplied from other apparatus via a network such as the Internet.

The communication unit 535, under control by the recorder controller 526, acquires encoded data such as video data, audio data, and EPG data transmitted from another apparatus via a network, and supplies it to the recorder controller 526. The recorder controller 526 supplies the acquired encoded data of video data and audio data to the recording/playback unit 533 for storage in the hard disk, for example. At this point, the recorder controller 526 and the recording/playback unit 533 may also be configured to conduct processing such as re-encoding as necessary.

The recorder controller 526 also decodes acquired encoded data of video data and audio data, and supplies the obtained video data to the display converter 530. The display converter 530 processes video data supplied from the recorder controller 526 and supplies it to the monitor 560 via the display controller 532 for display on its screen, similarly to video data supplied from the video decoder 525.

It may also be configured such that the recorder controller 526 also supplies decoded audio data to the monitor 560 via the D/A converter 534 and causes the audio to be output from the speakers so as to match the image display.

Furthermore, the recorder controller 526 decodes acquired encoded data of EPG data and supplies the decoded EPG data to the EPG data memory 527.

The hard disk recorder 500 as above uses the image decoding apparatus 101 as the video decoder 525, the decoder 552, and the internal decoder inside the recorder controller 526. Consequently, streams that have been encoded and output in the ascending order illustrated in A of FIG. 2, which differs from the H.264/AVC encoding order, are input into and decoded by the video decoder 525, the decoder 552, and the internal decoder inside the recorder controller 526 in that stream order. In so doing, pipeline processing and parallel processing can be realized with high coding efficiency. Additionally, the circuit sizes of the respective decoders can be reduced.

Consequently, the hard disk recorder 500 is able to realize faster processing while also generating highly accurate predicted images. As a result, the hard disk recorder 500 is able to obtain decoded images in higher definition from encoded data of video data received via a tuner, encoded data of video data read out from the hard disk of the recording/playback unit 533, and encoded data of video data acquired via a network, for example, and cause them to be displayed on the monitor 560.

The hard disk recorder 500 also uses the image encoding apparatus 51 as the encoder 551. Consequently, the encoder 551 conducts encoding and stream output in the ascending order illustrated in A of FIG. 2, which differs from the H.264/AVC encoding order, similarly to the case of the image encoding apparatus 51. In so doing, pipeline processing and parallel processing can be realized with high coding efficiency. Additionally, the circuit size of the encoder 551 can be reduced.

Consequently, the hard disk recorder 500 is able to realize faster processing while also improving the coding efficiency of encoded data recorded to a hard disk, for example. As a result, the hard disk recorder 500 is able to use the storage area of the hard disk more efficiently.

Although the foregoing describes a hard disk recorder 500 that records video data and audio data to a hard disk, any type of recording medium obviously may be used. For example, the image encoding apparatus 51 and the image decoding apparatus 101 can be applied similarly to the case of the hard disk recorder 500 discussed above even for a recorder that implements a recording medium other than a hard disk, such as flash memory, an optical disc, or video tape.

### [Exemplary Configuration of Camera]

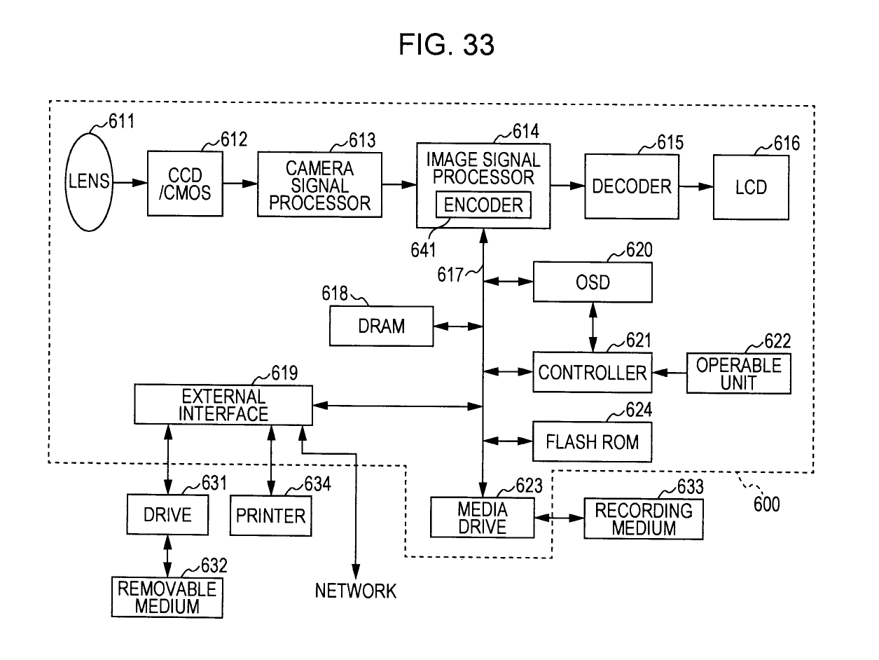

FIG. 33 is a block diagram illustrating an exemplary primary configuration of a camera which uses an image decoding apparatus and an image encoding apparatus to which the present invention has been applied.

The camera 600 illustrated in FIG. 3 shoots a subject and may display an image of the subject on an LCD 616 or record to a recording medium 633 as image data.

A lens block 611 causes light (i.e., a reflection of the subject) to be incident on a CCD/CMOS 612. The CCD/CMOS 612 is an image sensor using a CCD or CMOS, which converts the strength of received light into an electrical signal and supplies it to a camera signal processor 613.

The camera signal processor 613 converts an electrical signal supplied from the CCD/CMOS 612 into Y, Cr, and Cr chroma signals, and supplies them to an image signal processor 614. The image signal processor 614, under control by a controller 621, may perform given image processing on an image signal supplied from the camera signal processor 613, or encode an image signal in MPEG format, for example, with an encoder 641. The image signal processor 614 supplies a decoder 615 with encoded data which has been generated by encoding an image signal. Furthermore, the image signal processor 614 acquires display data generated by an on-screen display (OSD) 620 and supply it to the decoder 615.

In the processing above, the camera signal processor 613 suitably utilizes dynamic random access memory (DRAM) 618 connected via a bus 617, storing information such as image data and encoded data obtained by encoding such image data in the DRAM 618 as necessary.

The decoder 615 decodes encrypted data supplied from the image signal processor 614 and supplies the obtained image data (decoded image data) to the LCD 616. The LCD 616 suitably composites images of decoded image data supplied from the decoder 615 with images of display data and displays the composited images.

The on-screen display 620, under control by the controller 621, outputs display data such as icons and menu screens consisting of symbols, text, or graphics to the image signal processor 614 via the bus 617.

The controller 621 executes various processing while also controlling components such as the image signal processor 614, the DRAM 618, an external interface 619, the on-screen display 620, and a media drive 623, on the basis of signals expressing the content of commands that the user issues using an operable unit 622. Programs and data, etc. required for the controller 621 to execute various processing are stored in flash ROM 624.

For example, the controller 621 is able to encode image data stored in the DRAM 618 and decode encoded data stored in the DRAM 618 instead of the image signal processor 614 and the decoder 615. At this point, the controller 621 may be configured to conduct encoding/decoding processing according to a format similar to the encoding/decoding format of the image signal processor 614 and the decoder 615, or be configured to conduct encoding/decoding processing according to a format that is incompatible with the image signal processor 614 and the decoder 615.

As another example, in the case where instructions to initiate image printing are issued from the operable unit 622, the controller 621 reads out image data from the DRAM 618 and supplies it via the bus 617 to a printer 634 connected to the external interface 619 for printing.

As a further example, in the case where instructions for image recording are issued from the operable unit 622, the controller 621 reads out encoded data from the DRAM 618 and supplies it via the bus 617 to a recording medium 633 loaded into the media drive 623 for storage.

The recording medium 633 is an arbitrary rewritable storage medium such as a magnetic disk, a magneto-optical disc, an optical disc, or semiconductor memory, for example. The recording medium 633 is obviously an arbitrary type of removable medium, and may also be a tape device, a disk, or a memory card. Obviously, it may also be a contactless IC card, etc.

Also, it may also be configured such that the media drive 623 and the recording medium 633 are integrated and comprise a non-portable storage medium such as an internal hard disk drive or a solid-state drive (SSD), for example.

The external interface 619 comprises USB input/output ports, for example, to which the printer 634 is connected in the case of printing an image. A drive 631 may also be connected to the external interface 619 as necessary, with a removable medium 632 such as a magnetic disk, an optical disc, or a magneto-optical disc suitably loaded, wherein a computer program is read out therefrom and installed to the flash ROM 624 as necessary.

Additionally, the external interface 619 includes a network interface connected to a given network such as a LAN or the Internet. The controller 621, following instructions from the operable unit 622, is able to read out encoded data from the DRAM 618 and cause it to be supplied from the external interface 619 to another apparatus connected via a network. Also, the controller 621 is able to acquire, via the external interface 619, encoded data and image data supplied from another apparatus via a network and store it in the DRAM 618 or supply it to the image signal processor 614.

A camera 600 like the above uses the image decoding apparatus 101 as the decoder 615. Consequently, a stream that has been encoded and output in the ascending order illustrated in A of FIG. 2, which differs from the H.264/AVC encoding order, is input into and decoded by the decoder 615 in that stream order, similarly to the case of the image decoding apparatus 101. In so doing, pipeline processing and parallel processing can be realized with high coding efficiency. Additionally, the circuit size of the respective decoders can be reduced.

Consequently, the camera 600 is able to realize faster processing while also generating highly accurate predicted images. As a result, the camera 600 is able to obtain decoded images in higher definition from image data generated in the CCD/CMOS 612, encoded data of video data read out from the DRAM 618 or the recording medium 633, or encoded data of video data acquired via a network, for example, and cause them to be displayed on the LCD 616.

Also, the camera 600 uses the image encoding apparatus 51 as the encoder 641. Consequently, the encoder 641 conducts encoding and stream output in the ascending order illustrated in A of FIG. 2, which differs from the H.264/AVC encoding order, similarly to the case of the image encoding apparatus 51. In so doing, pipeline processing and parallel processing can be realized with high coding efficiency. Additionally, the circuit size of the encoder 641 can be reduced.

Consequently, the camera 600 is able to realize faster processing while also improving the coding of efficiency of encoded data recorded to a hard disk, without making processing complex. As a result, the camera 600 is able to use the storage area of the DRAM 618 and the recording medium 633 more efficiently.

Meanwhile, it may also be configured such that the decoding method of the image decoding apparatus 101 is applied to the decoding processing conducted by the controller 621. Similarly, it may also be configured such that the encoding method of the image encoding apparatus 51 is applied to the encoding processing conducted by the controller 621.

Also, the image data shot by the camera 600 may be motion images or still images.

Obviously, the image encoding apparatus 51 and the image decoding apparatus 101 are also applicable to apparatus and systems other than the apparatus discussed above.

### REFERENCE SIGNS LIST

51 image encoding apparatus
66 lossless encoder
74 intra prediction unit
75 address controller
76 nearby pixel availability determination unit
81 encoding processor
82 stream output unit
91 block address computation unit
92 pipeline/parallel processing controller
101 image decoding apparatus
112 lossless decoder
121 intra prediction unit
122 address controller
123 nearby pixel availability determination unit
131 stream input unit
132 decoding processor
141 block address computation unit
142 pipeline/parallel processing controller
300 television receiver
400 mobile phone
500 hard disk recorder
600 camera

1. An image processing apparatus, comprising:
address controlling means for determining, on the basis of an order that differs from that of an encoding standard, the one or more block addresses of one or more target blocks to be processed next from among the blocks constituting a given block of an image;
encoding means for conducting a prediction process using pixels near the one or more target blocks and encoding the one or more target blocks corresponding to the one or more block addresses determined by the address controlling means; and
stream outputting means for outputting the one or more target blocks as a stream in the order encoded by the encoding means.

2. The image processing apparatus according to claim 1, wherein
in the case where the given block is composed of 16 blocks with the upper-left block taken to be (0,0) and blocks enclosed in curly brackets { } indicating that they may be processed by pipeline processing, parallel processing, or in any order, the address controlling means determines the one or more block addresses of the one or more target blocks on the basis of the order (0,0), (1,0), {(2,0), (0,1)}, {(3,0), (1,1)}, {(2,1), (0,2)}, {(3,1), (1,2)}, {(2,2), (0,3)}, {(3,2), (1,3)}, (2,3), (3,3).

3. The image processing apparatus according to claim 2, further comprising:
nearby pixel availability determining means for using the one or block addresses determined by the address controlling means to determine whether or not pixels near the one or more target blocks are available;
wherein
the encoding means encodes the one or more target blocks by conducting a prediction process using pixels near the one or more target blocks in prediction modes that use nearby pixels determined to be available by the nearby pixel availability determining means.

4. The image processing apparatus according to claim 2, further comprising:
processing determining means for using the one or more block addresses determined by the address controlling means to determine whether or not the one or more target blocks can be processed by pipeline processing or parallel processing;
wherein
in the case where it is determined by the processing determining means that the one or more target blocks can be processed by pipeline processing or parallel processing, the encoding means encodes the target blocks by pipeline processing or parallel processing.

5. The image processing apparatus according to claim 2, wherein
the given block is an m×m pixel (where m≧16) macroblock, and
blocks constituting the given block are m/4×m/4 pixel blocks.

6. The image processing apparatus according to claim 2, wherein
the given block is an m×m pixel (where m≧32) macroblock or a sub-block constituting part of the macroblock, and
blocks constituting the given block are 16×16 pixel blocks.

7. An image processing method including steps whereby an image processing apparatus
determines, on the basis of an order that differs from that of an encoding standard, the one or more block addresses of one or more target blocks to be processed next from among the blocks constituting a given block of an image,
conducts a prediction process using pixels near the one or more target blocks and encodes the one or more target blocks corresponding to the determined one or more block addresses, and
outputs the one or more target blocks as a stream in the encoded order.

8. An image processing apparatus, comprising:
decoding means for decoding one or more target blocks to be processed next, the one or more target blocks being blocks constituting a given block of an image which have been encoded and then output as a stream in an order in the given block that differs from that of an encoding standard, with the decoding means decoding the one or more target blocks in the stream order;
address controlling means for determining the one or more block addresses of the one or more target blocks on the basis of the order that differs from that of an encoding standard;
predicting means for using pixels near the one or more target blocks to predict one or more predicted images of the one or more target blocks corresponding to the one or more block addresses determined by the address controlling means; and
adding means for adding one or more predicted images of the one or more target blocks predicted by the predicting means to one or more images of the one or more target blocks decoded by the decoding means.

9. The image processing apparatus according to claim 8, wherein
in the case where the given block is composed of 16 blocks with the upper-left block taken to be (0,0) and blocks enclosed in curly brackets { } indicating that they may be processed by pipeline processing, parallel processing, or in any order, the address controlling means determines the one or more block addresses of the one or more target blocks on the basis of the order (0,0), (1,0), {(2,0), (0,1)}, {(3,0), (1,1)}, {(2,1), (0,2)}, {(3,1), (1,2)}, {(2,2), (0,3)}, {(3,2), (1,3)}, (2,3), (3,3).

10. The image processing apparatus according to claim 9, further comprising:
nearby pixel availability determining means for using the one or block addresses determined by the address controlling means to determine whether or not pixels near the one or more target blocks are available;
wherein
the decoding means also decodes prediction mode information for the one or more target blocks, and
the predicting means uses pixels near the one or more target blocks determined to be available by the nearby pixel availability determining means to predict one or more predicted images of the one or more target blocks in one or more prediction modes indicated by the prediction mode information.

11. The image processing apparatus according to claim 9, further comprising:
processing determining means for using the one or more block addresses determined by the address controlling means to determine whether or not the one or more target blocks can be processed by pipeline processing or parallel processing;
wherein
in the case where it is determined by the processing determining means that the one or more target blocks can be processed by pipeline processing or parallel processing, the encoding means predicts predicted images of the target blocks by pipeline processing or parallel processing.

12. The image processing apparatus according to claim 9, wherein
the given block is an m×m pixel (where m≧16) macroblock, and
blocks constituting the given block are m/4×m/4 pixel blocks.

13. The image processing apparatus according to claim 9, wherein
the given block is an m×m pixel (where m≧32) macroblock or a sub-block constituting part of the macroblock, and
blocks constituting the given block are 16×16 pixel blocks.

14. An image processing method including steps whereby an image processing apparatus
decodes one or more target blocks to be processed next, the one or more target blocks being blocks constituting a given block of an image which have been encoded and then output as a stream in an order in the given block that differs from that of an encoding standard, with the one or more target blocks being decoded in the stream order,
determines the one or more block addresses of the one or more target blocks on the basis of the order that differs from that of an encoding standard,
uses pixels near the one or more target blocks to predict one or more predicted images of the one or more target blocks corresponding to the determined one or more block addresses, and
adds one or more predicted images of the one or more target blocks thus predicted to one or more images of the decoded one or more target blocks.
